(19) United States
(12) Patent Application Publication
(10) Pub. No.: US 2010/0262558 A1
(43) Pub. Date: Oct. 14, 2010

(54) Incorporating Development Tools In System For Deploying Computer Based Process On Shared Infrastructure

(76) Inventors: Nigel Edwards, Bristol (GB); Guillaume Alexandre Belrose, Marlborough (GB); Jerome Rolia, Kanata (CA); Sven Graupner, Mountain View, CA (US); Lawrence Wilcock, Wiltshire (GB); John Manley, Bristol (GB); Bryan Stephenson, Palo Alto, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/808,223

(22) PCT Filed: Dec. 20, 2007
(86) PCT No.: PCT/US07/88315

§ 371 Date: Jun. 15, 2010

(51) Int. Cl. G06Q 10/00; G06F 9/44

(52) U.S. Cl. 705/348; 717/100

(57) ABSTRACT

A method of setting up a development environment for development work on a computer based business process, involves providing a software model (827) of the business process, and providing in the model a representation (870) of tools for developing part of the process, incorporated with the corresponding part of the modelled business process. The selected parts of the model incorporating the tools are deployed, and the given tools installed, to set up the development environment. By modelling the development tools incorporated in the business process, setting up the development environment can be made easier. Choice and arrangement of tools needs less manual input, so risks of errors, and time spent in setting up can be reduced.

### RELATED APPLICATIONS

This application relates to copending U.S. applications of even date titled “MODEL BASED DEPLOYMENT OF COMPUTER BASED BUSINESS PROCESS ON DEDICATED HARDWARE” (applicant reference number 200702144), titled “VISUAL INTERFACE FOR SYSTEM FOR DEPLOYING COMPUTER BASED PROCESS ON SHARED INFRASTRUCTURE” (applicant reference number 200702356), titled “MODELLING COMPUTER BASED BUSINESS PROCESS FOR CUSTOMISATION AND DELIVERY” (applicant reference number 200702363), titled “MODELLING COMPUTER BASED BUSINESS PROCESS AND SIMULATING OPERATION” (applicant reference number 200702377), titled “AUTOMATED MODEL GENERATION FOR COMPUTER BASED BUSINESS PROCESS”, (applicant reference number 200702600), and titled “SETTING UP DEVELOPMENT ENVIRONMENT FOR COMPUTER BASED BUSINESS PROCESS”, (applicant reference number 200702145), and previously filed US application titled “DERIVING GROUNDED MODEL OF BUSINESS PROCESS SUITABLE FOR AUTOMATIC DEPLOYMENT” (Ser. No. 11/741878) all of which are hereby incorporated by reference in their entirety.

### FIELD OF THE INVENTION

The invention relates to methods of setting up a development environment for development work on a computer based business process and to corresponding systems and software.

### BACKGROUND

Physical IT (information technology) infrastructures are difficult to manage. Changing the network configuration, adding a new machine or storage device are typically complicated and error prone manual tasks. In most physical IT infrastructure, resource utilization is very low: 15% is not an uncommon utilization for a server, 5% for a desktop. To address this, modern computer infrastructures are becoming increasingly (re)-configurable and more use is made of shared infrastructure in the form of data centres provided by service providers.

Hewlett Packard's UDC (Utility Data Centre) is an example which has been applied commercially and allows automatic reconfiguration of physical infrastructure: processing machines such as servers, storage devices such as disks, and networks coupling the parts. Reconfiguration can involve moving or starting software applications, changing allocations of storage space, or changing allocation of processing time to different processes for example. Another way of contributing more reconfigurability, is by allowing many “virtual” computers to be hosted on a single physical machine. The term “virtual” usually means the opposite of real or physical, and is used where there is a level of indirection, or some mediation between the resource user and the physical resource.

In addition some computing fabrics allow the underlying hardware to be reconfigured. In once instance the fabric might be configured to provide a number of four-way computers. In another instance it might be re-configured to provide four times as many single processor computers.

It is extremely complex to model the full reconfigurability of the above. Models of higher level entities need to be recursive in the sense of containing or referring to lower level entities used or required to implement them (for example a virtual machine VM, may operate faster or slower depending on what underlying infrastructure is currently used to implement it (for example hardware partition nPAR or virtual partition vPAR, as will be described in more detail below). This means a model needs to expose the underlying configurability of the next generation computer fabrics—an nPAR consists of a particular hardware partition. This makes the models so complex that it becomes increasingly difficult for automated tools (and humans) to understand and process the models, to enable design and management of: a) the business process, b) the application and application configuration, and c) the infrastructure and infrastructure configuration.

The need to model the full reconfigurability and recursive nature of a system is exemplified in the DMTF's profile for “System Virtualization, Partitioning and Clustering”: http://www.dmtf.org/apps/org/workgroup/redundancy/

Another example of difficulties in modelling is WO2004090684 which relates to modelling systems in order to perform processing functions. It says “The potentially large number of components may render the approach impractical. For example, an IT system with all of its hardware components, hosts, switches, routers, desktops, operating systems, applications, business processes, etc. may include millions of objects. It may be difficult to employ any manual or automated method to create a monolithic model of such a large number of components and their relationships. This problem is compounded by the typical dynamic nature of IT systems having frequent adds/moves/changes. Secondly, there is no abstraction or hiding of details, to allow a processing function to focus on the details of a particular set of relevant components while hiding less relevant component details. Thirdly, it may be impractical to perform any processing on the overall system because of the number of components involved.”

Aris from IDS-Scheer is a known business process modelling platform having a model repository containing information on the structure and intended behaviour of the system. In particular, the business processes are modelled in detail. It is intended to tie together all aspects of system implementation and documentation.

Aris UML designer is a component of the Aris platform, which combines conventional business process modelling with software development to develop business applications from process analysis to system design. Users access process model data and UML content via a Web browser, thereby enabling processing and change management within a multi-user environment. It can provide for creation and communication of development documentation, and can link object-oriented design and code generation (CASE tools).

It takes a substantial amount of time and effort to build development systems: the necessary computing infrastructure and software tools required for application and system developers. The more complex the application or system under development, the more complex and time consuming is this task. Developers have to make choices as to how much time they invest in building their development system versus time spent developing the required application or system. The temptation is to avoid spending time building the development system, but this can lead to difficulties later on: inadequate monitoring, debugging and testing tools; an infrastructure that inadequately models the target deployed or production environment leading to inadequate testing. There have been attempts to automatically and rapidly provide computing infrastructures: HP's Utility Data Center, HP Lab's SoftUDC, HP's Caveo and Amazon's Elastic Compute Cloud (which can be seen at http://www.amazon.com/gp/browse.html?node=201590011). All of these provide computing infrastructures of one form or another, and some have been targeted at testers and developers, e.g. HP's Utility Data Center.

However, the complex task of manually selecting and configuring test and development tools to be deployed within the provisioned infrastructure still remains. There have also been examples of providing utility services: e.g. HP's SASU (Shared Application Service Utility). Here the user is provided with a service such as a web application server that they can use. However, they don't have control over the infrastructure, and monitoring, testing services or development tools have to be deployed and installed manually by the user.

### SUMMARY OF THE INVENTION

An object is to provide improved apparatus or methods. In one aspect the invention provides:

A method of setting up a development environment for development work on a computer based business process, the method having the steps of:

providing a model of the business process, the model representing functional steps of the business process, an arrangement of software application components, for carrying out the functional steps, and a design of computing infrastructure, for running the software application components, optionally to meet given non functional requirements when deployed,

providing in the model a representation of one or more tools for developing part of the business process, incorporated with a corresponding part of the modelled business process, and

deploying at least part of the model incorporating the tools, and installing the given tools, to set up the development environment.

By modelling the development tools incorporated in the business process, setting up the development environment can be made easier. Risks of errors, and time spent in setting up can be reduced. Furthermore, it enables human developers to be more productive with less knowledge, experience or skills, or enables developers of a given level of skill, knowledge or experience to handle more complex business processes for example. Having a model of the business process enables these advantages. Providing a model can encompass generating the model or retrieving it from a store for example. The modelling and deployment with tools incorporated can also help enable more efficient use of available computing resource, which is particularly useful for the common situation of shared resources, or for large scale or complex processes. By making it easier to set up an environment, it is likely that operators will be more willing to release resources more quickly when the environment is not being used. Hence again efficiency of usage of the resources can be improved.

Embodiments of the invention can have any additional features, without departing from the scope of the claims, and some such additional features are set out in dependent claims and in embodiments described below.

Another aspect provides software on a machine readable medium which when executed carries out the above method.

Another aspect provides a management system for setting up a development environment with tools for development work on a computer based business process, the management system having:

a store for storing a model of the business process, the model representing functional steps of the business process, an arrangement of software application components, for carrying out the functional steps, and a design of computing infrastructure, for running the software application components, optionally to meet given non functional requirements when deployed,

the model having a representation of one or more tools for developing part of the process, incorporated with a corresponding part of the modelled business process, and

a deployment part arranged to deploy at least part of the model incorporating the tools, and to install the given tools, to set up the development environment.

Other aspects can encompass corresponding steps by human operators using the system, to enable direct infringement or inducing of direct infringement in cases where the infringers system is partly or largely located remotely and outside the jurisdiction covered by the patent, as is feasible with many such systems, yet the human operator is using the system and gaining the benefit, from within the jurisdiction. Other advantages will be apparent to those skilled in the art, particularly over other prior art. Any of the additional features can be combined together, and combined with any of the aspects, as would be apparent to those skilled in the art. The embodiments are examples only, the scope is not limited by these examples, and many other examples can be conceived within the scope of the claims.

### BRIEF DESCRIPTION OF THE FIGURES

Specific embodiments of the invention will now be described, by way of example, with reference to the accompanying Figures, in which:

FIG. 1 shows a schematic view of an embodiment showing models, adaptive infrastructure and a management system,

FIG. 2 shows a schematic view of some operation steps by an operator and by the management system, according to an embodiment,

FIG. 3 shows a schematic view of some of the principal actions and models according to an embodiment,

FIG. 4 shows a schematic view of a sequence of steps from business process to deployed model in the form of a model information flow, MIF, according to another embodiment,

FIG. 5 shows a sequence of steps and models according to another embodiment,

FIG. 6 shows steps in deriving a grounded model according to an embodiment,

FIG. 7 shows an arrangement of master and slave application servers for a distributed design, according to an embodiment,

FIG. 8 shows parts of a master application server for the embodiment of FIG. 7,

FIG. 9 shows an arrangement of virtual entities on a server, for use in an embodiment,

FIG. 10 shows an example of a sales and distribution business process (SD) Benchmark Dialog Steps and Transactions,

FIG. 11 shows an example Custom Model Instance for SD Benchmark,

FIG. 12 shows a class diagram for an Unbound Model Class,

FIG. 13 shows an example of a template suitable for a decentralised SD example,

FIG. 14 shows a Grounded Model instance for a decentralized SD,

FIG. 15 shows another example of a template, suitable for a centralised secure SD example,

FIG. 16 shows an overview of an embodiment of a system

FIGS. 17, 18 and 19 show embodiments of methods,

FIG. 20 shows an example of a test environment set up according to the embodiment of FIG. 19,

FIG. 21 shows an embodiment of another method,

FIG. 22 shows an example of development tools set up according to the embodiment of FIG. 21

FIG. 23 shows steps according to another embodiment, and

FIG. 24 shows relationships between IDEs, tools, subsystems and infrastructure designs represented by a mapping according to an embodiment, and

FIG. 25 shows steps according to an embodiment using a template.

### DESCRIPTION OF SPECIFIC EMBODIMENTS

Definitions:

“non-functional requirements” can be regarded as how well the functional steps are achieved, in terms such as performance, security properties, cost, and others. It is explained in Wikipedia (http://en.wikipedia.org/wiki/Non-functional_requirements) for non-functional requirements as follows—“In systems engineering and requirements engineering, non-functional requirements are requirements which specify criteria that can be used to judge the operation of a system, rather than specific behaviors. This should be contrasted with functional requirements that specify specific behavior or functions. Typical non-functional requirements are reliability, scalability, and cost. Non-functional requirements are often called the ilities of a system. Other terms for non-functional requirements are “constraints”, “quality attributes” and “quality of service requirements”.”

Functional steps can encompass any type of function of the business process, for any purpose, such as interacting with an operator receiving inputs, retrieving stored data, processing data, passing data or commands to other entities, and so on, typically but not necessarily, expressed in human readable form. . . .

“Deployed” is intended to encompass a modelled business process for which the computing infrastructure has been allocated and configured, and the software application components have been installed and configured ready to become operational. According to the context it can also encompass a business process which has started running.

“suitable for automated deployment” can encompass models which provide machine readable information to enable the infrastructure design to be deployed, and to enable the software application components to be installed and configured by a deployment service, either autonomously or with some human input guided by the deployment service.

“business process” is intended to encompass any process involving computer implemented steps and optionally other steps such as human input or input from a sensor or monitor for example, for any type of business purpose such as service oriented applications, for sales and distribution, inventory control, control or scheduling of manufacturing processes for example. It can also encompass any other process involving computer implemented steps for non business applications such as educational tools, entertainment applications, scientific applications, any type of information processing including batch processing, grid computing, and so on. One or more business process steps can be combined in sequences, loops, recursions and branches to form a complete Business Process. Business process can also encompass business administration processes such as CRM, sales support, inventory management, budgeting, production scheduling and so on, and any other process for commercial or scientific purposes such as modelling climate, modelling structures, or modelling nuclear reactions.

“application components” is intended to encompass any type of software element such as modules, subroutines, code of any amount usable individually or in combinations to implement the computer implemented steps of the business process. It can be data or code that can be manipulated to deliver a business process step (BPStep) such as a transaction or a database table. The Sales and Distribution (SD) product produced by SAP is made up of a number of transactions each having a number of application components for example.

“unbound model” is intended to encompass software specifying in any way, directly or indirectly, at least the application components to be used for each of the computer implemented steps of the business process, without a complete design of the computing infrastructure, and may optionally be used to calculate infrastructure resource demands of the business process, and may optionally be spread across or contain two or more sub-models. The unbound model can also specify the types or versions of corresponding execution components such as application servers and database servers, needed by each application component, without specifying how many of these are needed for example.

“grounded model” is intended to encompass software specifying in any way, directly or indirectly, at least specifying a complete design of the computing infrastructure suitable for automatic deployment of the business process. It can be a complete specification of a computing infrastructure and the application components to be deployed on the infrastructure.

“bound model” encompasses any model having a binding of the Grounded Model to physical resources. The binding can be in the form of associations between ComputerSystems, Disks, StorageSystems, Networks, NICS that are in the Grounded Model to real physical parts that are available in the actual computing infrastructure.

“infrastructure design template” is intended to encompass software of any type which determines design choices by indicating in any way at least some parts of the computing infrastructure, and indicating predetermined relationships between the parts. This will leave a limited number of options to be completed, to create a grounded model. These templates can indicate an allowable range of choices or an allowable range of changes for example. They can determine design choices by having instructions for how to create the grounded model, or how to change an existing grounded model.

“computing infrastructure” is intended to encompass any type of resource such as hardware and software for processing, for storage such as disks or chip memory, and for communications such as networking, and including for example servers, operating systems, virtual entities, and management infrastructure such as monitors, for monitoring hardware, software and applications. All of these can be “designed” in the sense of configuring and/or allocating resources such as processing time or processor hardware configuration or operating system configuration or disk space, and instantiating software or links between the various resources for example. The resources may or may not be shared between multiple business processes. The configuring or allocating of resources can also encompass changing existing configurations or allocations of resources. Computing infrastructure can encompass all physical entities or all virtualized entities, or a mixture of virtualized entities, physical entities for hosting the virtualized entities and physical entities for running the software application components without a virtualized layer.

“parts of the computing infrastructure” is intended to encompass parts such as servers, disks, networking hardware and software for example.

“server” can mean a hardware processor for running application software such as services available to external clients, or a software element forming a virtual server able to be hosted by a hosting entity such as another server, and ultimately hosted by a hardware processor.

“AIService” is an information service that users consume. It implements a business process.

“Application Constraints Model” can mean arbitrary constraints on components in the Customized Process, Application Packaging and Component Performance Models. These constraints can be used by tools to generate additional models as the MIF progresses from left to right.

“ApplicationExecutionComponent” is for example a (worker) process, thread or servlet that executes an Application component. An example would be a Dialog Work Process, as provided by SAP.

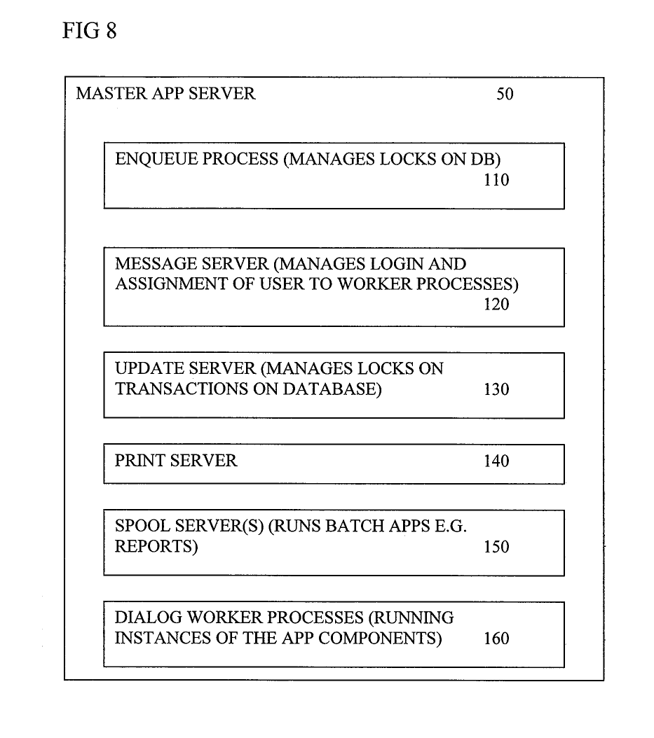

“ApplicationExecutionService” means a service which can manage the execution of ApplicationExecutionComponents such as Work Processes, servlets or data-base processes. An example would be an Application Server as provided by SAP. Such an application server includes the collection of dialog work processes and other processes such as update and enqueue processes as shown in the diagram of the master application server. (FIG. 8).

“Application Packaging Model” is any model which describes the internal structure of the software: what products are needed and what modules are required from the product, and is typically contained by an unbound model.

“Application Performance Model” means any model which has the purpose of defining the resource demands, direct and indirect, for each Business process (BP) step. It can be contained in the unbound model.

“Component Performance Model” can mean any model containing the generic performance characteristics for an Application Component. This can be used to derive the Application Performance Model (which can be contained in the unbound model), by using the specific Business process steps and data characteristics specified in the Custom Model together with constraints specified in the Application Constraints Model.

“Custom Model” means a customized general model of a business process to reflect specific business requirements.

“Deployed Model” means a bound model with the binding information for the management services running in the system.

“Candidate Grounded Model” can be an intermediate model that may be generated by a tool as it transforms the Unbound Model into the Grounded Model.

“Grounded Component” can contain the installation and configuration information for both Grounded Execution Components and Grounded Execution Services, as well as information about policies and start/stop dependencies.

“Grounded Execution Component” can be a representation in the Grounded Model of a (worker) process, thread or servlet that executes an Application Component.

“Grounded Execution Service” is a representation in the Grounded Model of the entity that manages the execution of execution components such as Work Processes, servlets or database processes.

“Infrastructure Capability Model” can be a catalogue of resources that can be configured by the utility such as different computer types and devices such as firewalls and load balancers.

MIF (Model Information Flow) is a collection of models used to manage a business process through its entire lifecycle.

The present invention can be applied to many areas, the embodiments described in detail can only cover some of those areas. It can encompass modelling dynamic or static systems, such as enterprise management systems, networked information technology systems, utility computing systems, systems for managing complex systems such as telecommunications networks, cellular networks, electric power grids, biological systems, medical systems, weather forecasting systems, financial analysis systems, search engines, and so on. The details modelled will generally depend on the use or purpose of the model. So a model of a computer system may represent components such as servers, processors, memory, network links, disks, each of which has associated attributes such as processor speed, storage capacity, disk response time and so on. Relationships between components, such as containment, connectivity, and so on can also be represented.

An object-oriented paradigm can be used, in which the system components are modeled using objects, and relationships between components of the system are modeled either as attributes of an object, or objects themselves. Other paradigms can be used, in which the model focuses on what the system does rather than how it operates, or describes how the system operates. A database paradigm may specify entities and relationships. Formal languages for system modelling include text based DMTF Common Information Model (CIM), Varilog, NS, C++, C, SQL, or graphically expressed based schemes.

### ADDITIONAL FEATURES

Some examples of additional features for dependent claims are as follows:

The software components and computing infrastructure can have an association with corresponding tools and the template can be used to ensure the tools selected correspond to the software components and computing infrastructure.

The model of the tool can be incorporated in a template which allows some parameters to be selectable, and the model of the tool can be completed by selecting parameters allowed by the templates. This enables the number of parameters to be chosen to be limited to ease the set up, and reduce the risk of untested or illegal combinations of parameters being entered.

The template can contain configuration information to enable the installation of the tools to include setting up interfaces with the deployed parts of the model of the business process. This can further help reduce the load on the developer and reduce the chance of errors. Wherever the tools are deployed, whether on the same physical machine or remotely, they will need some interface which can be complex and time consuming to set up in many cases.

The system can be arranged to prompt the developer to select the template from a number of predetermined templates of computing infrastructure design, at least part of the required tools being incorporated in the template.

The system can be arranged to present options constrained by the template to an operator for selecting and configuring the tools. This can help reduce the time and effort and skill needed to select or configure the tool correctly.

The template can provide a mapping of logical components of an unbound model of the parts of the business process and of the model of the selected tools on to the computing infrastructure, to provide a grounded model of the business process, with the selected tools incorporated, suitable for automated deployment on the physical infrastructure, the template allowing some parameters to be selectable, the method involving completing the grounded model by selecting parameters allowed by the template. This can help enable some of the advantages of generating the unbound model to be realised, by providing a way to find a better or best configuration of the software or the mapping to the computing infrastructure, to lead to more efficient usage of available resources for live deployments. Particularly for more complex systems there is notable benefit in incorporating IDEs and tools into the infrastructure sooner, during the generation of the mapping of the unbound model on to the computing infrastructure, rather than later as a separate post mapping step or post deployment step. This can lead to more efficient deployments.

The tools can being part of an integrated development environment associated with at least one of the software application components, and the model can have a representation of the integrated development environment in the model. Such environments can be complex and time consuming to set up, so there is even more benefit in incorporating parts of it in the model for deployment at the same time as the process being developed or monitored.

The tools can comprise testing tools arranged to provide test inputs, and monitoring of parts of a process for a deployment under test conditions. Such testing typically can be complex and time consuming to set up, so there can be corresponding benefits from incorporating tools for this in the model for deployment at the same time as the process being developed or monitored.

The management system can be arranged to generate the representations of the development tools.

The design of computing infrastructure can comprise virtualized entities. This increases the flexibility but can add considerably to the complexity of setting up, and so the advantages set out above apply particularly in this case.

The determining of an arrangement of tools can be carried out according to an input representing an authorisation level of the developer. This can enable security or quality control considerations to be addressed for example. The authorization level of operator can reflect security clearance, training level or skill level, employee/contractor status and so on as desired.

The system can additionally be arranged to determine requirements for physical infrastructure to be allocated for the deployment step and for the installing of the given tools. This can help enable the deployment and installation to be made with less human input, and so with less chance of errors and so on. Where the infrastructure is shared such as in a data centre this can help improve efficiency of use of resources.

Where the enterprise desires to deploy on dedicated hardware local to the enterprise, yet have the benefits of management by a service provider, then this can add another layer of complexity when setting up a development environment. Reference is made to above referenced copending application number 200702144 for more details of examples of this. In these circumstances, assisting developers to set up development environments can become all the more important.

Where a 3-D visual interface is provided with a game server to enable multiple developers to work on the same model and see each others changes, developers can navigate complex models more quickly. Reference is made to above referenced copending application number 200702356 for more details of examples of this. Combining this with assisting developers to set up development environments can enable the advantages of both to be enhanced.

Where an enterprise interface is provided to enable the enterprise to customise the non functional requirements independently of each other, then the service provider may need more development effort to meet the customised requirements. Reference is made to above referenced copending application number 200702363 for more details of examples of this. Combining this with assisting developers to set up development environments can enable the advantages of both to be enhanced.

Where the operation of the business process can be simulated or where multiple test deployments can be made in parallel, development can be accelerated. Reference is made to above referenced copending application number 200702377 for more details of examples of this. Combining this with assisting developers to set up development environments can enable the advantages of both to be enhanced.

Where annotations are inserted in the source code to assist in modelling or in documentation, then documenting the history of changes can be made easier. Reference is made to above referenced copending application number 200702600 for more details of examples of this. Combining this with assisting developers to set up development environments can enable the advantages of both to be enhanced.

### INTRODUCTION TO EMBODIMENTS

In some embodiments, developers can submit specifications in the form of models of their desired infrastructure, software application components, monitoring, development and debugging tools. The deployment part in the form of a hosting platform creates the target infrastructure, and deploys the applications, monitoring, development and debugging tools. Examples of this model based approach are described in more detail below. The modelled tools can be included in templates for the infrastructure design. Previously templates had only included the components needed to implement the business process and the management components required to manage that business process. A notable feature of at least some embodiments of the invention is to include development and testing tools in the above. This is useful for many because it is common for SAP systems to undergo at least three distinct phases.

1. Development

2. Test and Quality Assurance

3. Production

Development and testing tools, as well as management components are applicable to phase 1 and phase 2. In some cases they are applicable to phase 3 for system diagnosis. We will use the same techniques for including testing and development tools in the templates as we do for application components: testing and development tools are just specialized applications. Here are some examples of testing and development tools (the list is not intended to be comprehensive).

“LoadRunner”, “QuickTest”, IDEs (See above referenced co pending case ref 200702145 entitled “Method for configuring integrated development and infrastructure management environments”), “QualityCenter” (and other tools for assessing and managing risks of changes), and “Business Availability Center”

For phase 3, production SAP systems, a change to the system might be to deploy appropriate testing and other tools for system diagnosis, once the diagnosis was complete, the tools could be removed. Thus instructions for making these changes would be contained in the templates. The templates can also be used to manage change as described in above referenced previously filed disclosure 200700455 “Using templates in automated model-based system design”. Some advantages of the features described are as follows:

It can reduce the time and effort needed to deploy development and testing tools along with their associated infrastructures and target applications. Because the configuration is automated and driven from templates it is more likely to be correct and encapsulate best practice for the tools. The opportunity for human error is substantially reduced. The utility provider is able to offer and promote tools of their choosing, such as management, testing and development tools. Developers would become familiar with these tools—the hosting platform makes it easy for them to try out. If their experience was positive, they would be more likely to choose the same software in future tasks.

Model Based Approach

A general aim of this model based approach is to enable development and management to provide matched changes to three main layers: the functional steps of the process, the applications used to implement the functional steps of the process, and configuration of the computing infrastructure used by the applications. Such changes are to be carried out automatically by use of appropriate software tools interacting with models modelling the above mentioned parts. Until now there has not been any attempt to link together tools that integrate business process, application and infrastructure management through the entire system lifecycle.

Model-Based technologies to automatically design and manage Enterprise Systems—see “Adaptive Infrastructure meets Adaptive Applications”, by Brand et al, published as an external HP Labs Tech Report:

http://www.hpl.hp.com/techreports/2007/HPL-2007-138.html

and incorporated herein by reference, can provide the capability to automatically design, deploy, modify, monitor, and manage a running System to implement a business process, while minimizing the requirement for human involvement.

A model-based approach for management of such complex computer based processes will be described. Such models can have structured data models in CIM/UML to model the following three layers:
Infrastructure elements, such as physical machines, VMs, operating systems, network links.
Application elements, such as Databases, application servers.
Business level elements, such as functional steps of business processes running in the application servers.

A model is an organized collection of elements modelled in UML for example. A goal of some embodiments is to use these data models for the automated on-demand provision of enterprise applications following a Software as a service (SaaS) paradigm. More details of an example of using a series of models for such purposes will now be described. If starting from scratch, a business process is designed using a business process modelling tool. The business process is selected from a catalog of available business processes and is customized by the business process modelling tool. An available business process is one that can be built and run. There will be corresponding templates for these as described below. Then non-functional characteristics such as reliability and performance requirements are specified.

Next the software entities such as products and components required to implement the business process are selected. This is done typically by searching through a catalog of product models in which the model for each product specifies what business process is implemented. This model is provided by an application expert or the product vendor.

Next the computing infrastructure such as virtual machines, operating systems, and underlying hardware, is designed. This can use templates as described in more detail below, and in above referenced previously filed application Ser. No. 11/741878 “Using templates in automated model-based system design” incorporated herein by reference. A template is a model that has parameters and options, by filing in the parameters and selecting options a design tool transforms the template into a complete model of a deployable system. This application shows a method of modelling a business process having a number of computer implemented steps using software application components, to enable automatic deployment on a computing infrastructure, the method having the steps of:

automatically deriving a grounded model of the business process from an unbound model of the business process, the unbound model specifying the application components to be used for each of the computer implemented steps of the business process, without a complete design of the computing infrastructure, and the grounded model specifying a complete design of the computing infrastructure suitable for automatic deployment of the business process,

the deriving of the grounded model having the steps of providing an infrastructure design template having predetermined parts of the computing infrastructure, predetermined relationships between the parts, and having a limited number of options to be completed, generating a candidate grounded model by generating a completed candidate infrastructure design based on the infrastructure design template, and generating a candidate configuration of the software application components used by the unbound model, and evaluating the candidate grounded model, to determine if it can be used as the grounded model.

Next the physical resources from the shared resource pool in the data center are identified and allocated. Finally the physical resources are configured and deployed and ongoing management of the system can be carried out. All of this can use SAP R/3 as an example, but is also applicable to other SAP systems and non-SAP systems.

Problem Statement

The design of the hardware infrastructure and software landscape for large business processes such as enterprise applicationenterprise applications is an extremely complex task, requiring human experts to design the software and hardware landscape. Once the enterprise application has been deployed, there is an ongoing requirement to modify the hardware and software landscape in response to changing workloads and requirements. This manual design task is costly, time-consuming, error-prone, and unresponsive to fast-changing workloads. The embodiments describe mechanisms to automatically create an optimised design for an enterprise application, monitor the running deployed system, and dynamically modify the design to best meet the non-functional requirements.

There are two basic inputs to the design process:
Specification of functional requirements. Typically, this is in the form of a set of business steps that the application is to support. These describe what the system is intended to do from the perspective of end users. The specification will specify the set of standard business steps required from a standard catalogue, and any system-specific customisations of these steps. This specification will determine the set of products and optional components that must be included in the design of a suitable software landscape for the enterprise application.
Specification of non-functional requirements. This defines the requirements that the design must meet, such as performance, security, reliability, cost, and maintainability. Examples of performance could include the total and concurrent number of users to be supported, transaction throughput, or response times.

The design process involves the creation of a specification of the hardware and software landscape of the enterprise application that will meet the functional and non-functional requirements described above. This can consist of:
A set of physical hardware resources, selected from an available pool. The infrastructure would consist of computers, memory, disks, networks, storage, and other appliances such as firewalls.
   A virtual infrastructure to be deployed onto the physical resources, together with an assigned mapping of virtual infrastructure to physical infrastructure. The virtual infrastructure must be configured in such a way to best take advantage of the physical infrastructure and support the requirements of the software running on it. For example, the amount of virtual memory or priority assigned to a virtual machine.
   A selection of appropriately configured software components and services, distributed across the virtual and physical infrastructure. The software must be configured to meet the system specific functional requirements, such as customisations of standard business processes. Additionally, the software must be configured to best make use of the infrastructure it is deployed on, while meeting both the functional and non-functional requirements. Configuration parameters could include the level of threading in a database, the set of internal processes started in an application server, or the amount of memory reserved for use by various internal operations of an application server.

A design for the Enterprise application can consist of:
Selection of appropriate quantities and types of physical and virtual infrastructure and software components
Configuration parameters for the infrastructure and software components and services.

The embodiments described below are concerned with an automated mechanism to create an optimised design for an enterprise application by modelling the enterprise application in order to simulate the effect of various design parameters, such that the most appropriate selections and configurations can be made. A model manager in the form of a Model-Based Design Service (MBDS) is responsible for the creation of a set of models of the system, each with slightly different parameters for selection, configuration, and evaluation possibilities. The design process can be simply regarded as a search for and selection of the best model, usually in terms of finding the least expensive model which meets the functional and non-functional requirements of the system.

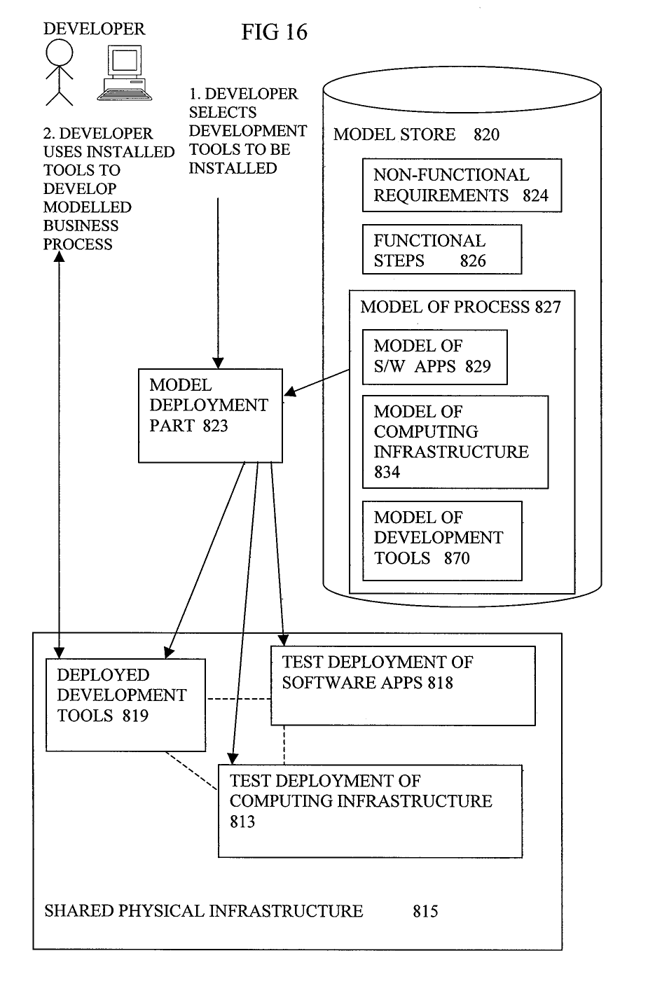

FIGS. 16-25, Embodiments of the Invention.

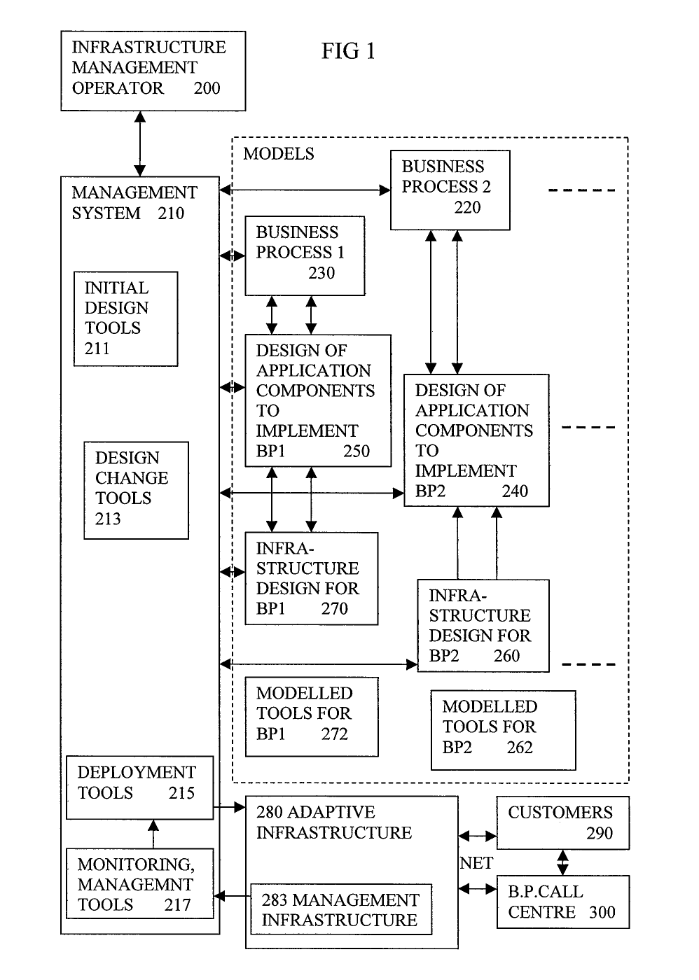

FIG. 16 shows an overview of an embodiment of the invention. This shows a model store 820, shared physical infrastructure 815 of the service provider, and various other parts involved in managing the models and the deployment of the models on the physical infrastructure. More details of a possible implementation of the models and parts for managing them are described later with reference to FIGS. 1 to 15. The parts for managing would typically be implemented as software services. A deployment part 823 takes the model and deploys it on the physical infrastructure. A model generation part (not shown) generates the model 827 of the computer based process. An interface for developers can be provided to enable input by the operator using the tools and make changes to corresponding entities in the model.

The model can have non functional requirements 824 for the process, and functional steps 826 of the process. The model of the process also comprises a model of software applications 829, for implementing the functional steps, and a model of computing infrastructure 834 for running the software applications. The model can also include modelled development tools 870 for deployment with the deployment of the business process for use by a developer The model is used to generate a deployed business process, deployed under test conditions, shown as test deployment of software applications 818 and test deployment of computing infrastructure 813 in the shared physical infrastructure 815, together with deployed development tools 819, incorporated with the test deployment of the business process. The deployment can be in dedicated rather than shared infrastructure in principle.

The development tools can include for instance one or more IDEs, and associated tools selected by a developer to constitute a development environment for the developer to develop the business process. This can encompass high level development at the level of functional steps, or lower level development of software application components or computing infrastructure. As shown, the developer inputs to the model deployment part an indication of which development tools are to be installed. If choices need to be made about configuring or installing the tools, the developer may be prompted to make these choices. Subsequently the developer uses the installed tools to do the development work on the business process.

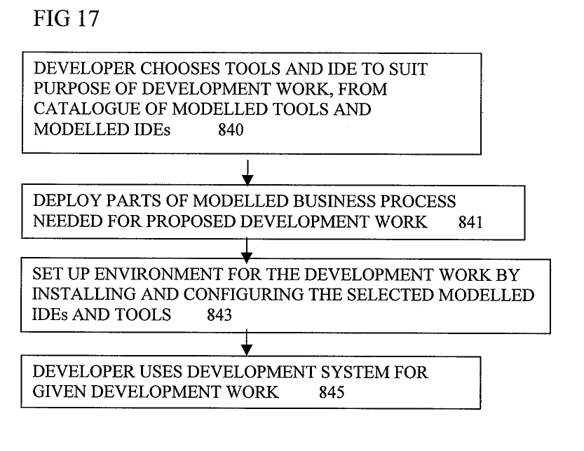

FIG. 17 shows some of the principal steps carried out by the system of FIG. 16. according to an embodiment. At step 840, a developer chooses tools and one or more IDEs to suit the purpose of the development work (e.g. design, functional test, performance test, integration test, and so on), from a catalogue of modelled tools and modelled IDEs for example. At step 841, parts of the modelled business process needed for the proposed development work are deployed, together with the selected tools. At step 843, the environment is set up for the development work, by installing and configuring the selected IDEs and tools. This enables the developer to carry out the intended development work using the development environment at step 845. When the work is completed or stopped, the resources can be released.

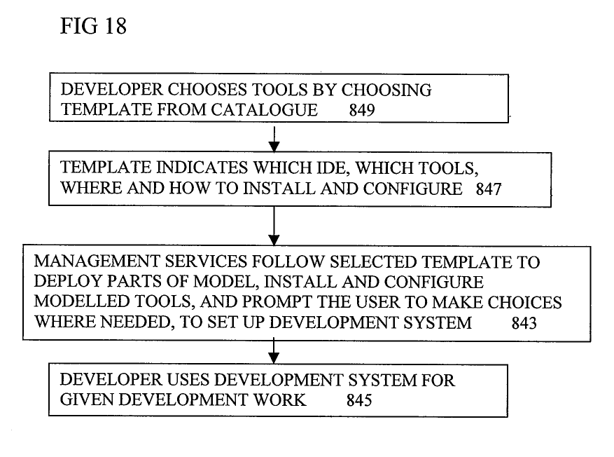

FIG. 18 shows another embodiment using a template to assist the setting up of the development environment. At step 849 the developer chooses appropriate tools by choosing a template incorporating appropriate tools from a catalog of such templates. The template indicates for example which IDE, which tools, and where and how to install and configure them, at step 847. Management services follow the selected template to deploy parts of the model, install and configure modelled tools and prompt the user to make choices where needed, to set up the development system. This enables the developer to carry out the intended development work using the development environment at step 845.

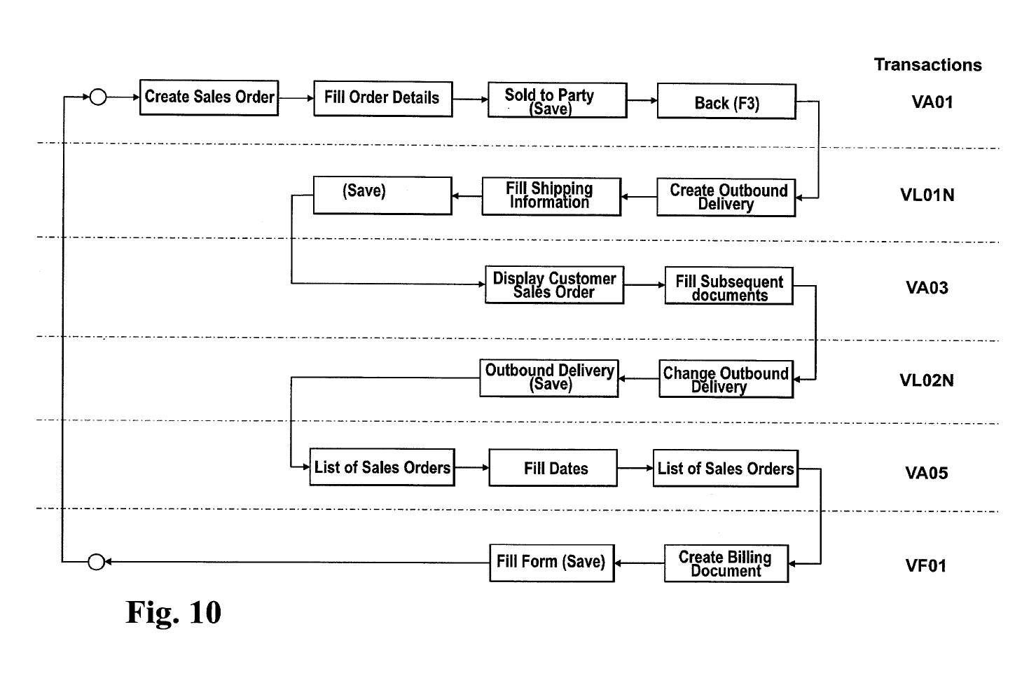

FIG. 19 shows another embodiment using a template to assist the setting up of a particular development environment for load testing of a business process to check its performance when tested with inputs under controlled conditions. At step 849 the developer chooses appropriate tools by choosing a template incorporating appropriate tools from a catalog of such templates. The template in this case is used to prompt the developer to choose from a limited selection of tools at step 762. The developer chooses at step 764 to use a tool called loadrunner for carrying out the load testing. Guided by the template, the developer chooses configuration parameters such as where to install the loadrunner program, where to couple the virtual user inputs generated by loadrunner into the deployed business process, and where in the deployed business process to monitor its operation. At step 765, the deployment part deploys the selected parts of the model. An installer part installs the loadrunner controller, virtual users and monitors and so on, at step 767, to complete the setting up of the development environment. At step 768, the developer uses this development environment to carry out the work, by using the loadrunner controller to exercise the deployed business process or parts of it, and monitor the performance.

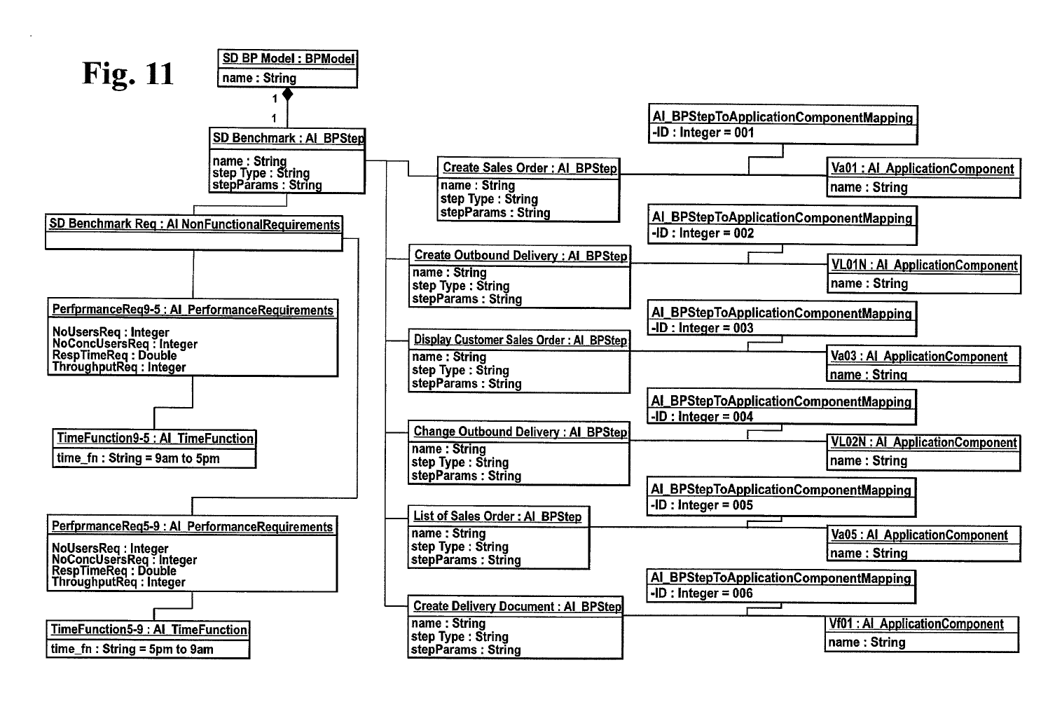

FIG. 20 shows the development environment set up according to FIG. 19. Particular software application components under test 937 are run by computing infrastructure in the form of virtual servers under test 932, running on physical servers under test 946. A loadrunner controller and operator interface 902 is used to create many loadrunner virtual users 922 which feed test inputs to test the business process. Software agents 945 are shown coupled to the software application components of the business process, to generate monitoring events to be fed back to the loadrunner controller. Hardware and/or operating system monitors 947 are also shown coupled to the virtual and physical infrastructure under test, to monitor their operation, and feedback performance indications to the loadrunner controller.

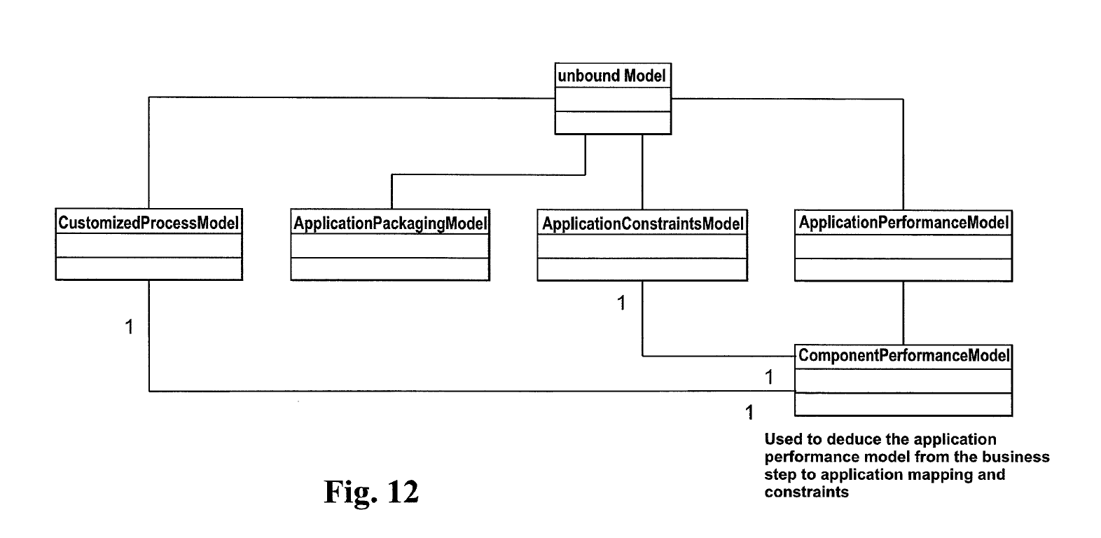

FIG. 21 shows another embodiment using a template to assist the setting up of a particular development environment for development using an IDE. At step 849 the developer chooses appropriate tools by choosing a template incorporating appropriate tools from a catalog of such templates. The template in this case is used to prompt the developer to choose from a limited selection of tools at step 762. The developer chooses at step 957 an IDE and an infrastructure editor, and guided by the template, chooses a configuration of e.g. where to install, where to find source code, where to find target machine and so on. The deployment part deploys the selected parts of the modelled business process at step 765. The installer installs the IDE and infrastructure editor at step 958. At step 959, the developer uses the IDE and infrastructure editor to develop the business process.

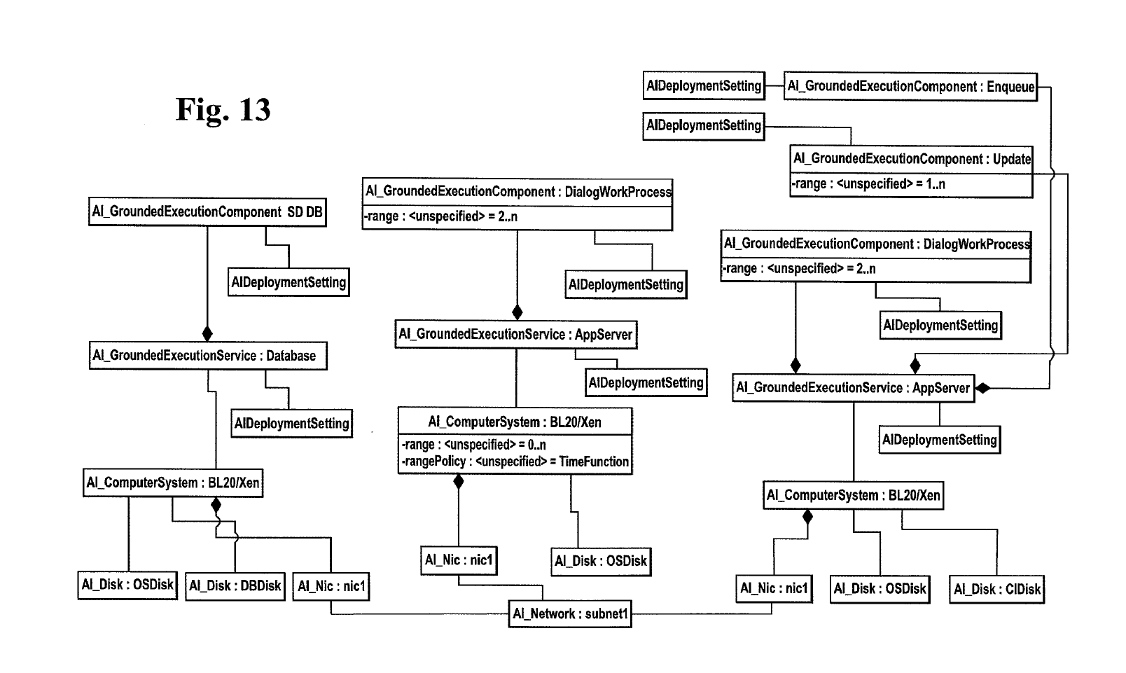

FIG. 22 shows the development environment set up according to FIG. 21. Parts 975 for implementing the business process are shown on the left side, and development tools 973 are shown on the right side. Particular software application components 977 are run by computing infrastructure in the form of virtual servers 972, running on physical servers 976. Development tools 973 include external parts of tools 974, such as operator interface, change management policies and so on. Source code 982 is shown for the software parts such as the software application components of the process. An IDE 952 with tools for software development is shown coupled to the software application components being developed. The infrastructure editing and validating tools 954 are shown coupled to the virtual servers and physical servers. The IDE and infrastructure editing tools may be incorporated in the model so that they can be deployed in the same step as deploying the business process rather than in a subsequent step.

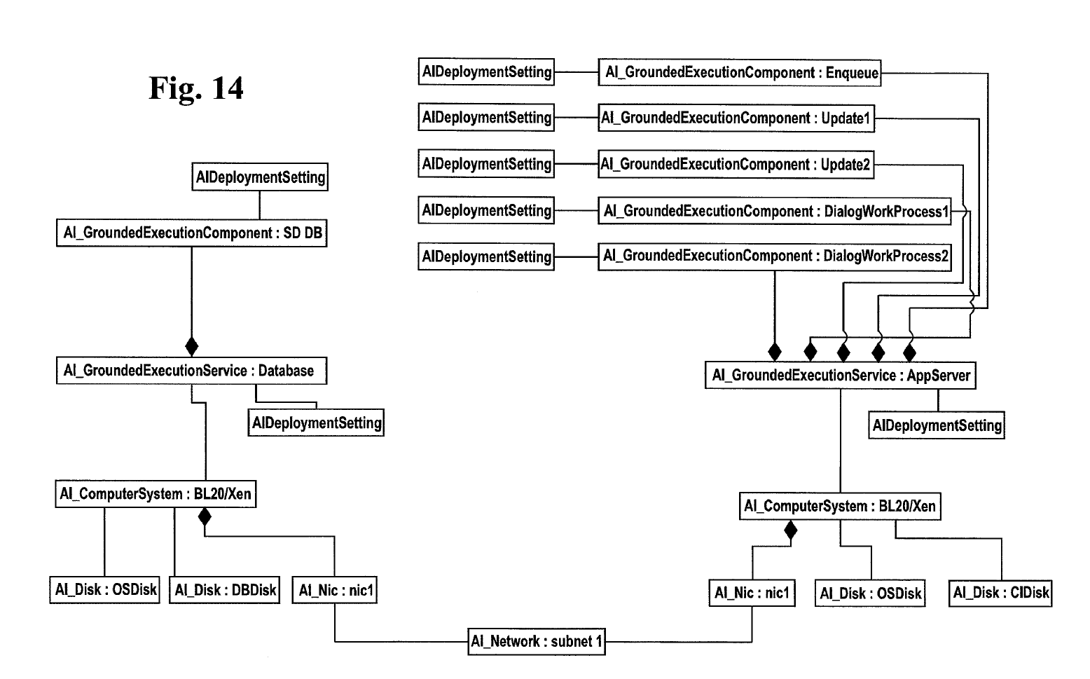

FIG. 23 shows steps of another embodiment having an agent for keeping a record of how a development environment is set up, to enable it to be recreated. At step 740, the developer or agent builds an environment with IDEs and tools for a specific purpose for working on part of a model. At step 750, a template is created to model an infrastructure for running the IDEs and tools, and to model the IDEs and tools so that they can be deployed and installed, based on a record of the environment built in the preceding step. This template is stored to enable later retrieval, at step 760. The choice of IDE and tools and their configuration can be stored as a simple list of items, or can be stored in the form of a program which guides the developer through the setting up, prompting the user for choices or decisions or authorisation as needed, to enable rapid and accurate setting up of the development environment when desired. When the developer stops work, at step 770, a share of shared resources used by the development environment, can be released for others to use. The developer can later choose to reinstate the same environment or a different environment by accessing the mapping according to purpose and part of the model.

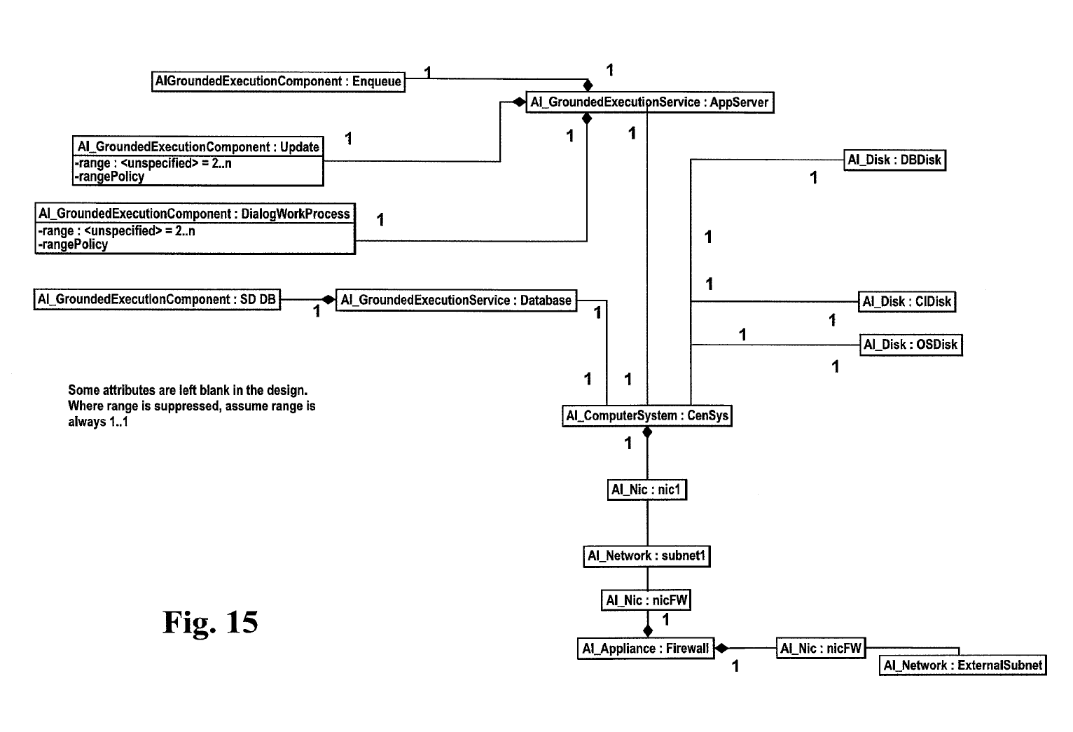

FIG. 24 shows relationships between some of the parts described, to illustrate the many possibilities and choices, and thus the benefit of capturing particular sets of correct choices in a model or template. The left hand side shows parts of development environment which need to be chosen and set up (labelled IDE model), and the right hand side shows various models of computing infrastructure suitable for hosting the development environment.

The IDE model has a choice of subsystems, 1 to N, each subsystem representing a different combination of entities such as parts of the modelled business process and any other external entities. There is a many to many relationship between these and the various different IDEs 1 to M. This represents the fact that each subsystem may have one or more correct or corresponding IDEs associated with or suitable for use with the software in that subsystem. The correct choice may depend on the purpose of the development work (not shown in this figure). A further many to many relationship exists between the tools and the IDEs, to represent the fact that only some of the tools 1 to O are suitable or compatible with a given IDE. Again, the correct choice may depend on the purpose of the development work. A further many to many relationship is shown between the IDE model and the infrastructure model, which has many infrastructure designs 1 to P, only some of which are suitable for, or optimum for the given choice of IDE and tools.

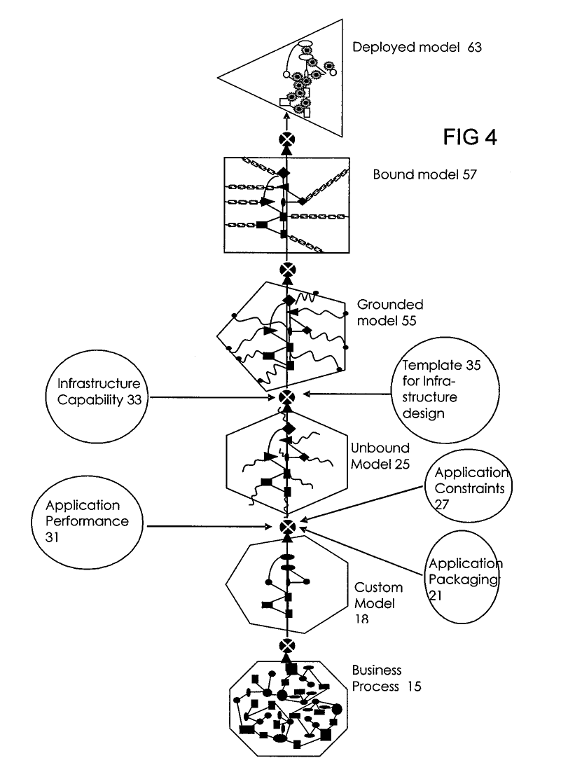

The subsystem can include any of the models in the flow shown in FIG. 4, described below, which have successively more layers starting at the business process layer and reaching down to software application components, virtual infrastructure and physical infrastructure layers.

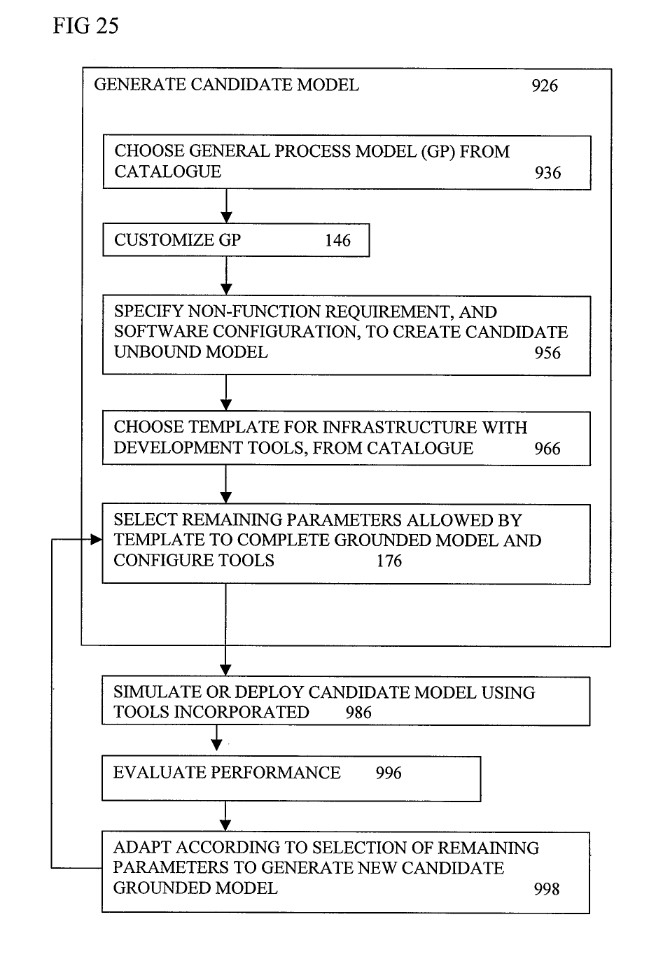

FIG. 25 shows another embodiment. In this case, a development process by an operator or developer is shown to refine a grounded model using a template. More details of examples of grounded models and templates will be discussed below with reference to FIG. 1 onwards. A candidate model is generated at step 926. It is deployed or its operation is simulated at step 986. Its performance is evaluated at step 996, and at step 998, the remaining parameters are adapted as allowed by the template. This adaptation is fed back to step 926. Step 926 involves a number of sub steps as follows. Step 936 shows choosing a general process model (GP) from a catalogue by an operator. This is a high level model only. It is customized at step 146 to complete the required functional steps without non functional requirements. At step 956 non-functional requirements are input by the operator. A template for the design of the computing infrastructure is selected at step 966. This may be done by the operator with automated guidance from the model manager which may assess the options and show a ranking of the best options. The remaining parameters left open by the template are then selected at step 176 by the operator again optionally with automated guidance from the model manager showing a ranking of the best options. The feedback from the evaluation of the last iteration can be added to this step 976, to speed up the development process.

The model-based approach can be applied to a single enterprise application.

Physical infrastructure and Virtual infrastructure can be regarded as subsets of computing infrastructure. A model based design service MBDS has a model store (model pool A) which has a number of candidate models of the same business process. Each candidate model comprises sub models corresponding to the four layers of the enterprise application. At each layer, the models can in some embodiments consist of both a Static Model and an Operational Model. The Static Model describes the static structure of the system—the selection and configuration options of candidate designs of the enterprise application. Additionally, the model includes detailed Operational Models of the internal structure, run-time operation, and performance demands (such as CPU, memory, disk, or network I/O) of the infrastructure and software. It is these Operational Models that allow the simulator to evaluate how well a candidate design will meet the non-functional requirements of the System.

An enterprise application can typically consist of multiple Deployment Modules, corresponding to deployable, distributable consistent sub-sets of the complete functionality of the deployed software. These deployment modules would form part of the Software Landscape Model. A key decision of the Design and modelling process is how to carve up the Application into these distributed parts and where to locate the Deployment Modules.
There can be functional and non functional requirements for the Enterprise application, entered by an operator or obtained from a store. A monitoring part can measure behaviour and/or performance of some or all of the layers of the Enterprise application when deployed.

Various mechanisms can be used for the creation, modification, and selection of models in the Model Pool:
Many models can be managed in the Model Pool, each of which is simulated and evaluated against the requirements. The models in the Model Pool form a candidate population set.
Models can be randomly mutated to vary the parameters of selection, configuration, and
   evaluation parameters. The degree and rate of modification may be affected by the discrepancy with the measured results.
Models can be categorised into related sets to create clusters of models, based on criteria such as giving similar results. Various heuristics and selection criteria can be applied to these clusters. For example, if many models in a cluster predict similar results, then this may be used as a way to increase the confidence in the predictions of those models.
The sensitivity of the predicted behaviour of the system to the model parameters may be used to drive the degree and rate of modification of model parameters.
Optimise the internal parameters of the Operational Model to improve the predictability and confidence of the models. This is achieved by comparison of predicted results with measured values and analysis of the sensitivity of model parameters.
The predicted system behaviour of candidate models, together with the associated selection and configuration parameters may be visualised and presented to human experts, who can then not only make selections of candidate designs but also direct the model mutation process. The scheme described above for a single enterprise application A can be applied, largely independently, to any number of additional services, all of which would run on the same shared Resource Pool.

The models can have concepts, such as Business Process, Business Process Steps, Business Object, and Software Component, together with the relationships between them.

The models should not be confused with the source content of the software of an enterprise application. There can be various kinds of Source Content. Typically the Source Content is owned by the enterprise application Vendor. There may be several forms of Source Content such as:
Program Code written in languages such as Java, or ABAP. This code may be created directly by humans, or automatically generated from other Program Models or tools.
Program Models describe an aspect of the system, such as its static structure, or run-time behaviour. Program Models are themselves expressed in some form of mark-up language, such as XML. Examples might be:
State and Action diagrams for the behaviour of software components.
Business Process diagrams describing the set of business process steps.
Structure diagrams describing the static packaging of the software into deployable units, executables and products.

Program Code or Program Models may be generated via tools, such as graphical editors, or directly by humans. The syntax and language used to describe Source Content may vary widely. Model Mark-up can be added as annotations to the Source Content, and should have consistent semantics, concepts, and identifiers if the annotations are to be used in generating or updating the model.

The model generation part can be implemented in various ways. One way is based on a six stage model flow called the Model Information Flow (MIF). This involves the model being developed in stages or phases which capture the lifecycle of the process from business requirements all the way to a complete running system. The six phases are shown in FIG. 4 described below and each has a corresponding type of model which can be summarised as follows:
General Model: The starting point, for example a high level description of business steps based on “out-of-the-box” functionalities of software packages the user can choose from.
Custom Process Model: defined above, and for example a specialization of the previous model (General Model) with choices made by the enterprise. This model captures non-functional requirements such as response time, throughput and levels of security. Additionally, it can specify modifications to the generic business processes for the enterprise.
Unbound Model: defined above, and for example an abstract logical description of a system capable of running the software with the requirements as specified by the enterprise.
Grounded Model: defined above and for example can be a transformation of the previous model (Unbound Model) to specify infrastructure choices, such as the quantities and types of hardware and virtualization techniques to use, and also the structure and configuration of the software to run the business process.
Bound Model: a grounded model for which resources in the data centre have been reserved.
Deployed Model: a grounded model where the infrastructure and the software components have been deployed and configured. At this point, the service is up and running.

Each stage of the flow has corresponding types of model which are stored in a Model Repository. Management services consume the models provided by the Model Repository and execute management actions to realize the transitions between phases, to generate the next model in the MIF. Those services can be for example:
Template-based Design Service (TDS) (and an example of a model based design service): translates non-functional requirements into design choices for a Grounded Model based on the template.
Resource Acquisition Service (RAS): its purpose is to allocate physical resources prior to the deployment of virtual resources, such as vms.
Resource Configuration Service (RCS): its role is to create/update the virtual and physical infrastructure.
Software Deployment Service (SDS): installs and configures the applications needed to run the business processes and potentially other software.
Monitoring Services (MS) deploys Probes to monitor behaviour of a Deployed Model. This can include monitoring at any one or more of these three levels:
   Infrastructure: e.g. to monitor CPU, RAM, network I/O usage regardless of which application or functional step is executing.
   Application: e.g. to monitor time taken or CPU consumption of a given application such as a DB process on the operating system, regardless of which particular infrastructure component is used.
   Business process: e.g. count the number of sales order per hour, regardless of which infrastructure components or applications are used.

Templates for the Computing Infrastructure Design

Templates are used to capture designs that are known to instantiate successfully (using the management services mentioned above). An example of template describes a SAP module running on a Linux virtual machine (vm) with a certain amount of memory. The templates also capture management operations that it is known can be executed, for instance migration of vm of a certain kind, increasing the memory of a vm, deploying additional application server to respond to high load, etc . . . If a change management service refers to the templates, then the templates can be used to restrict the types of change (deltas) that can be applied to the models.

Templates sometimes have been used in specific tools to restrict choices. Another approach is to use constraints which provide the tool and user more freedom. In this approach constraints or rules are specified that the solution must satisfy. One example might be that there has to be at least one application server and at least one database in the application configuration. These constraints on their own do not reduce the complexity sufficiently for typical business processes, because if there are few constraints, then there are a large number of possible designs (also called a large solution space). If there are a large number of constraints (needed to characterize a solution), then searching and resolving all the constraints is really hard—a huge solution space to explore. Also it will take a long time to find which of the constraints invalidates a given possible design from the large list of constraints.

Templates might also contain instructions for managing change. For example they can contain reconfiguration instructions that need to be issued to the application components to add a new virtual machine with a new slave application server.

The deriving of the grounded model can involve specifying all servers needed for the application components. This is part of the design of the adaptive infrastructure and one of the principal determinants of performance of the deployed business process. The template may limit the number or type of servers, to reduce the number of options, to reduce complexity of finding an optimised solution for example.

The deriving of the grounded model from the unbound model can involve specifying a mapping of each of the application components to a server. This is part of configuring the application components to suit the design of adaptive infrastructure. The template may limit the range of possible mappings, to reduce the number of options, to reduce complexity for example.

The deriving of the grounded model can involve specifying a configuration of management infrastructure for monitoring of the deployed business process in use. This monitoring can be at one or more different levels, such as monitoring the software application components, or the underlying adaptive infrastructure, such as software operating systems, or processing hardware, storage or communications.

More than one grounded model can be derived, each for deployment of the same business process at different times. This can enable more efficient use of resources for business processes which have time varying demand for those resources for example. Which of the grounded models is deployed at a given time can be switched over any time duration, such as hourly, daily, nightly, weekly, monthly, seasonally and so on. The switching can be at predetermined times, or switching can be arranged according to monitored demand, detected changes in resources such as hardware failures or any other factor.

Where the computing infrastructure has virtualized entities, the deriving of the grounded model can be arranged to specify one or more virtualized entities without indicating how the virtualised entities are hosted. It has now been appreciated that the models and the deriving of them can be simplified by hiding such hosting, since the hosting can involve arbitrary recursion, in the sense of a virtual entity being hosted by another virtual entity, itself hosted by another virtual entity and so on. The template can specify virtual entities, and map application components to such virtual entities, to limit the number of options to be selected, again to reduce complexity. Such templates will be simpler if they do not need to specify the hosting of the virtual entities. The hosting can be defined at some time before deployment, by a separate resource allocation service for example.

The grounded model can be converted to a bound model, by reserving resources in the adaptive infrastructure for deploying the bound model. At this point, the amount of resources needed is known, so it can be more efficient to reserve resources at this time than reserving earlier, though other possibilities can be conceived. If the grounded model is for a change in an existing deployment, the method can have the step of determining differences to the existing deployed model, and reserving only the additional resources needed.

The bound model can be deployed by installing and starting the application components of the bound model. This enables the business process to be used. If the grounded model is for a change in an existing deployment, the differences to the existing deployed model can be determined, and only the additional application components need be installed and started.

Two notable points in the modelling philosophy are the use of templates to present a finite catalogue of resources that can be instantiated, and not exposing the hosting relationship for virtualized resources. Either or both can help reduce the complexity of the models and thus enable more efficient processing of the models for deployment or changing after deployment.

Some embodiments can use an infrastructure capability model to present the possible types of resources that can be provided by a computing fabric. An instance of an infrastructure capability model contains one instance for each type of Computer System or Device that can be deployed and configured by the underlying utility computing fabric. Each time the utility deploys and configures one of these types, the configuration will always be the same. For a Computer System this can mean the following for example.
Same memory, CPU, Operating System
Same number of NICs with same I/O capacity
Same number of disks with the same characteristics

The templates can map the application components to computers, while the range of both application components and computers is allowed to vary. In addition the templates can also include some or all of the network design, including for example whether firewalls and subnets separate the computers in the solution. In embodiments described below in more detail, the Application Packaging Model together with the Custom Process Model show how the various application components can implement the business process, and are packaged within the Grounded Model.

The template selected can also be used to limit changes to the system, such as changes to the business process, changes to the application components, or changes to the infrastructure, or consequential changes from any of these. This can make the ongoing management of the adaptive infrastructure a more tractable computing problem, and therefore allow more automation and thus reduced costs. In some example templates certain properties have a range: for example 0 to n, or 2 to n. A change management tool (or wizard, or set of tools or wizards) only allows changes to be made to the system that is consistent with template. The template is used by this change management tool to compute the set of allowable changes, it only permits allowable changes. This can help avoid the above mentioned difficulties in computing differences between models of current and next state, if there are no templates to limit the otherwise almost infinite numbers of possible configurations.

Some of the advantages or consequences of these features are as follows:

1. Simplicity: by using templates it becomes computationally tractable to build a linked tool set to integrate business process, application and infrastructure design and management through the entire lifecycle of design, deployment and change.

2. By limiting the number of possible configurations of the adaptive infrastructure, the particular computing problem of having to compute the differences between earlier and later states of complex models is eased or avoided. This can help enable a management system for the adaptive infrastructure which can determine automatically how to evolve the system from an arbitrary existing state to an arbitrary desired changed state. Instead templates fix the set of allowable changes and are used as configuration for a change management tool.

3. The template models formally relate the business process, application components and infrastructure design. This means that designs, or changes, to any one of these can be made dependent on the others for example, so that designs or changes which are inconsistent with the others are avoided.

FIG. 1 Overview

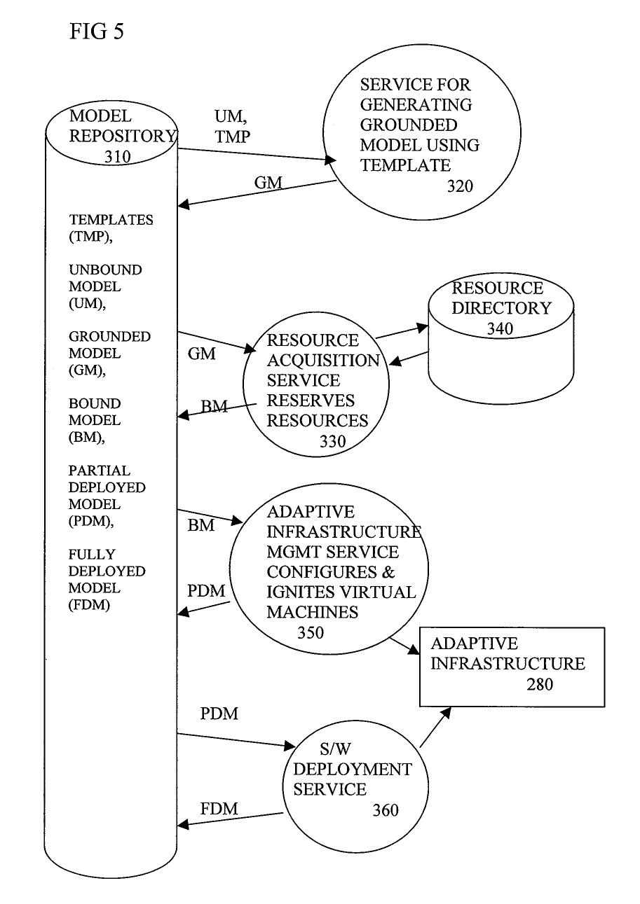

FIG. 1 shows an overview of infrastructure, applications, and management tools and models according to an embodiment. Adaptive infrastructure 280 is coupled typically over the internet to customers 290, optionally via a business process BP call centre 300. A management system 210 has tools and services for managing design and deployment and ongoing changes to deployed business processes, using a number of models. For example as shown, the management system has initial design tools 211, design change tools 213, deployment tools 215, and monitoring and management tools 217. These may be in the form of software tools such as the monitor part, the simulator and the model manager described above, running on conventional processing hardware, which may be distributed. Examples of initial design tools and design change tools are shown by the services illustrated in FIG. 5 described below.

A high level schematic view of some of the models is shown, for two business processes: there can be many more. Typically the management system belongs to a service provider, contracted to provide IT services to businesses who control their own business processes for their customers. A model 230 of business process 1 is used to develop a design 250 of software application components. This is used to create and infrastructure design 270 for running the application components to implement the business process. This design can then be deployed by the management system to run on the actual adaptive infrastructure, where it can be used for example by customers, a call centre and suppliers (not shown for clarity). Similarly, item 220 shows a model of a second business process, used to develop a design 240 of software application components. This is used to create and infrastructure design 260 for running the application components to implement the second business process. This design can then also be deployed by the management system to run on the actual adaptive infrastructure.

The model for BP1 also shows modelled development tools 272 and correspondingly, the model for BP2 shows its own modelled tools 262, for deployment with the modelled business process for development purposes.

The adaptive infrastructure can include management infrastructure 283, for coupling to the monitoring and management tools 217 of the management system. The models need not be held all together in a single repository: in principle they can be stored anywhere.

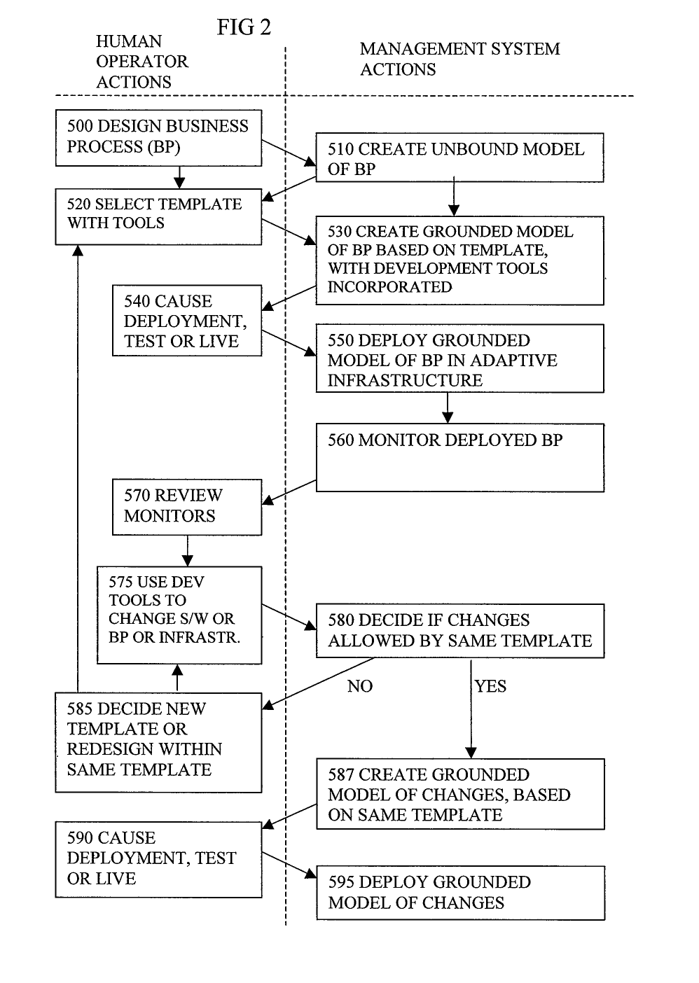

FIG. 2 Operation

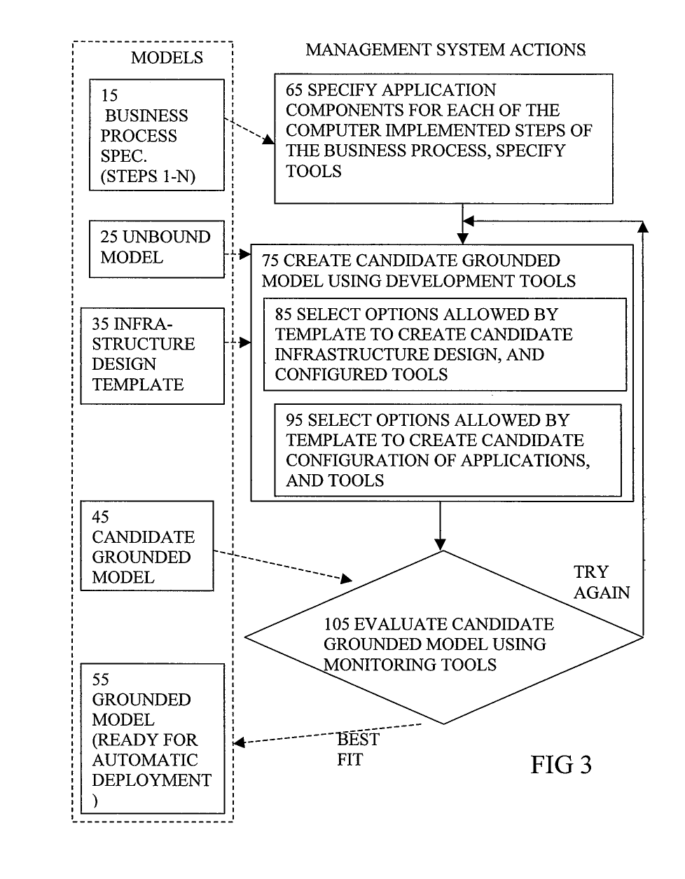

FIG. 2 shows a schematic view of some operation steps by an operator and by the management system, according to an embodiment. Human operator actions are shown in a left hand column, and actions of the management system are shown in the right hand column. At step 500 the human operator designs and inputs a business process (BP). At step 510 the management system creates an unbound model of the BP. At step 520, the operator selects a template for the design of the computing infrastructure, the template including particular tools for development purposes. At step 530, the system uses the selected template to create a grounded model of the BP from the unbound model and the selected template, the grounded model including deployments of the selected tools. In principle the selection of the template might be automated or guided by the system. The human operator of the service provider then causes the grounded model to be deployed, either as a live business process with real customers, or as a test deployment under controlled or simulated conditions. The suitability of the grounded model can be evaluated before being deployed as a live business process: an example of how to do this is described below with reference to FIG. 3.

At step 550, the system deploys the grounded model of the BP in the adaptive infrastructure. The deployed BP is monitored by a monitoring means of any type, and monitoring results are passed to the human operator. Following review of the monitoring results at step 570, the operator of the enterprise can design changes to the

BP or the operator of the service provider can design changes to the infrastructure at step 575, using the development tools deployed and installed from the template. These changes are input to the system, and at step 580 the system decides if changes are allowed by the same template. If no, at step 585, the operator decides either for a new template, involving a return to step 520, or for a redesign within the limitations of the same template, involving at step 587 the system creating a grounded model of the changes, based on the same template.

At step 590 the operator of the service provider causes deployment of the grounded model for test or live deployment. At step 595 the system deploys the grounded model of the changes. In principle the changes could be derived later, by generating a complete grounded model, and later determining the differences, but this is likely to be more difficult.

FIG. 3 Operation

FIG. 3 shows an overview of an embodiment showing some of the steps and models involved in taking a business process to automated deployment. These steps can be carried out by the management system of FIG. 1, or can be used in other embodiments.

A business process model 15 has a specification of steps 1-N. There can be many loops and conditional branches for example as is well known. It can be a mixture of human and computer implemented steps, the human input being by customers or suppliers or third parties for example. At step 65, application components are specified for each of the computer implemented steps of the business process, and selected development tools to be incorporated are also specified. At step 75, a complete design of computing infrastructure is specified automatically, based on an unbound model 25. This can involve at step 85 taking an infrastructure design template 35, and selecting options allowed by the template to create a candidate infrastructure design. This can include design of software and hardware parts and development tools incorporated with the parts for implementing the business process. At step 95, a candidate configuration of software application components including development tools allowed by the template is created, to fit the candidate infrastructure design. Together these form a candidate grounded model.

At step 105, the candidate grounded model is evaluated. If necessary, further candidate grounded models are created and evaluated using the development tools. Which of the candidates is a best fit to the requirements of the business process and the available resources is identified. There are many possible ways of evaluating, and many possible criteria, which can be arranged to suit the type of business process. The criteria can be incorporated in the unbound model for example.

There can be several grounded models each for different times or different conditions. For example, time varying non-functional requirements can lead to different physical resources or even a reconfiguration: a VM might have memory removed out-of-office hours because fewer people will be using it. One might even shutdown an underused slave application server VM. The different grounded models would usually but not necessarily come from the same template with different parameters being applied to generate the different grounded models.

The template, grounded and subsequent models can contain configuration information for management infrastructure and instructions for the management infrastructure, for monitoring the business process when deployed. An example is placing monitors in each newly deployed virtual machine which raise alarms when the CPU utilization rises above a certain level—e.g. 60%.

FIG. 4 MIF

FIG. 4 shows some of the principal elements of the MIF involved in the transition from a custom model to a deployed instance. For simplicity, it does not show the many cycles and iterations that would be involved in a typical application lifecycle—these can be assumed. The general model 15 of the business process is the starting point and it is assumed that a customer or consultant has designed a customized business process. That can be represented in various ways, so a preliminary step in many embodiments is customising it. A custom model 18 is a customization of a general model. So it is likely that a General Model could be modelled using techniques similar to the ones demonstrated for modelling the Custom

Model: there would be different business process steps. A custom model differs from the general model in the following respects. It will include non-functional requirements such as number of users, response time, security and availability requirements. In addition it can optionally involve rearranging the business process steps: new branches, new loops, new steps, different/replacement steps, steps involving legacy or external systems.

The custom model is converted to an unbound model 25 with inputs such as application performance 31, application packaging 21, and application constraints 27. The unbound model can specify at least the application components to be used for each of the computer implemented steps of the business process, without a complete design of the computing infrastructure. The unbound model is converted to a grounded model 55 with input from models of infrastructure capability 33, and an infrastructure design template 35.

Deployment of the grounded model can involve conversion to a bound model 57, then conversion of the bound model to a deployed model 63. The bound model can have resources reserved, and the deployed model involves the applications being installed and started.

FIG. 5 MIF

FIG. 5 shows a sequence of steps and models according to another embodiment.

This shows a model repository 310 which can have models such as templates (TMP), an unbound model (UM), a bound model (BM), a partial deployed model (PDM), a fully deployed model (FDM). The figure also shows various services such as a service 320 for generating a grounded model from an unbound model using a template. Another service is a resource acquisition service 330 for reserving resources using a resources directory 340, to create a bound model.

An adaptive infrastructure management service 350 can configure and ignite virtual machines in the adaptive infrastructure 280, according to the bound model, to create a partially deployed model. Finally a software deployment service 360 can be used to take a partially deployed model and install and start application components to start the business process, and create a fully deployed model.

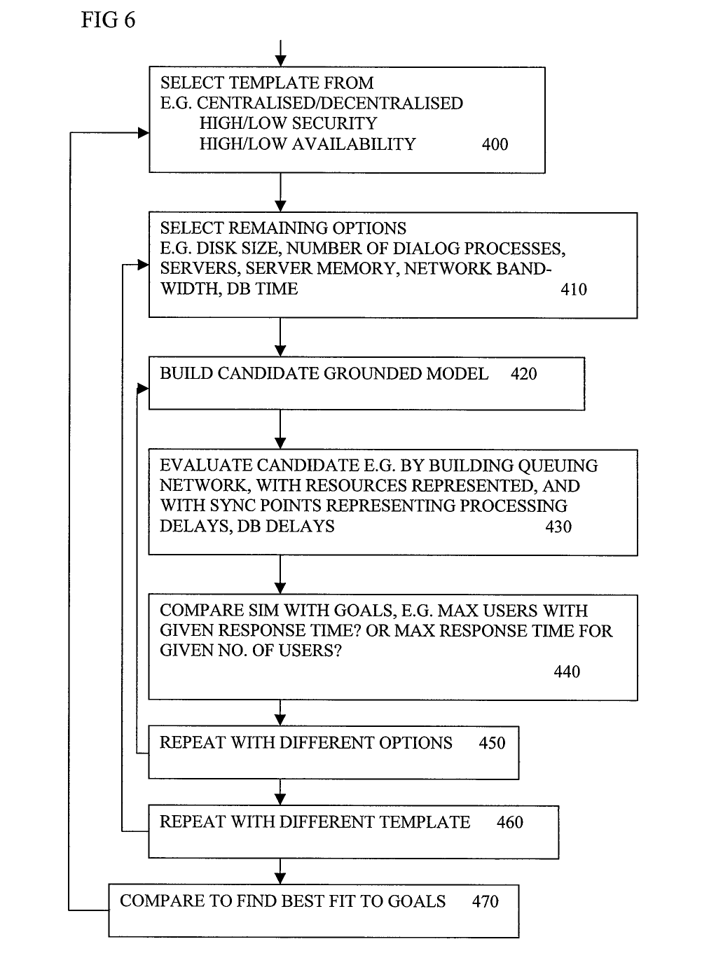

FIG. 6 Deriving Grounded Model

FIG. 6 shows steps in deriving a grounded model according to an embodiment. At step 400, a template is selected from examples such as centralised or decentralised arrangements. A centralised arrangement implies all is hosted on a single server or virtual server. Other template choices may be for example high or low security, depending for example on what firewalls or other security features are provided. Other template choices may be for example high or low availability, which can imply redundancy being provided for some or all parts.

At step 410, remaining options in the selected template are filled in. This can involve selecting for example disk sizes, numbers of dialog processes, number of servers, server memory, network bandwidth, server memory, network bandwidth, database time allowed and so on. At step 420, a candidate grounded model is created by the selections. Step 430 involves evaluating the candidate grounded model e.g. by building a queuing network, with resources represented, and with sync points representing processing delays, db delays and so on. Alternatively the evaluation can involve deploying the model in an isolated network with simulated inputs and conditions.

At step 440, the evaluation or simulation results are compared with goals for the unbound model. These can be performance goals such as maximum number of simultaneous users with a given response time, or maximum response time, for a given number of users. At step 450, another candidate grounded model can be created and tested with different options allowed by the template. At step 460 the process is repeated for one or more different templates. At step 470, results are compared to identify which candidate or candidates provides the best fit. More than one grounded model may be selected, if for example the goals or requirements are different at different times for example. In this case, the second or subsequent grounded model can be created in the form of changes to the first grounded model.

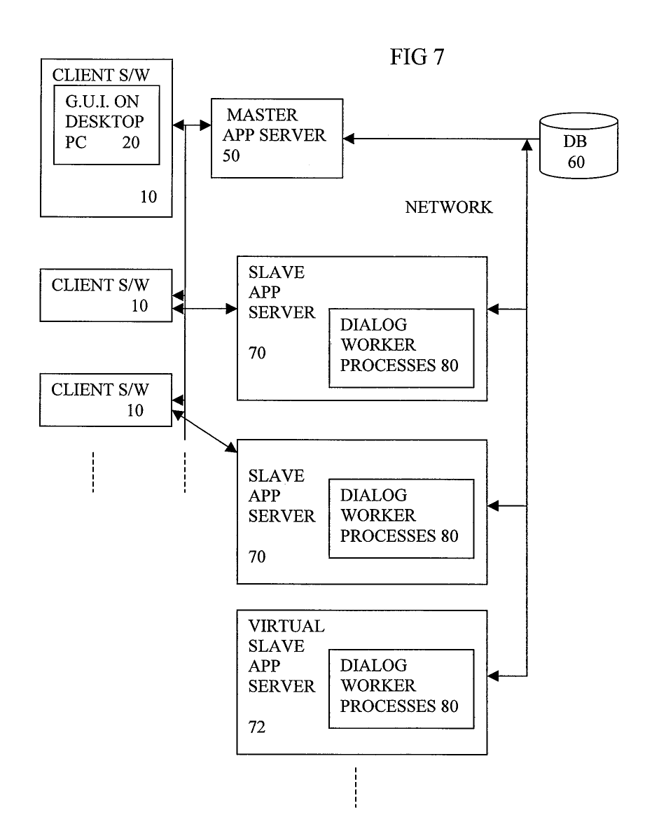

FIG. 7 Master and Slave Application Servers

FIG. 7 shows an arrangement of master and slave application servers for a decentralised or distributed design of computing infrastructure, according to an embodiment. A master application server 50 is provided coupled by a network to a database 60, and to a number of slave application servers 70. Some of the slaves can be implemented as virtual slave application servers 72. Each slave can have a number of dialog worker processes 80. The master application server is also coupled to remote users using client software 10. These can each have a graphical user interface GUI on a desktop PC 20 coupled over the internet for example. The slaves can be used directly by the clients once the clients have logged on using the master.

FIG. 8 Master Application Server

FIG. 8 shows parts of a master application server for the embodiment of FIG. 7, An enqueue process 110 is provided to manage locks on the database. A message server 120 is provided to manage login of users and assignment of users to slave application servers for example. An update server 130 is provided for managing committing work to persistent storage in a database. A print server 140 can be provided if needed. A spool server 150 can be provided to run batch tasks such as reports. At 160 dialog worker processes are shown for running instances of the application components.

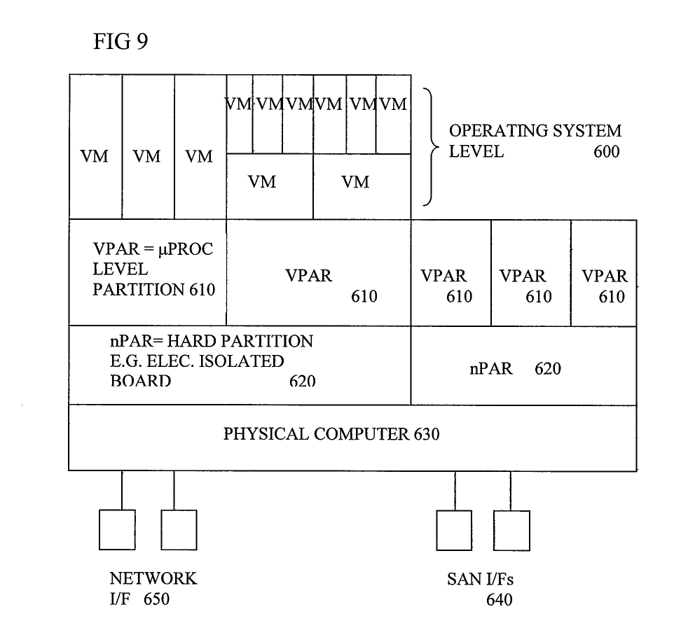

FIG. 9 Virtual Entities

FIG. 9 shows an arrangement of virtual entities on a server, for use in an embodiment. A hierarchy of virtual entities is shown. At an operating system level there are many virtual machines VM. Some are hosted on other VMs. Some are hosted on virtual partitions VPARs 610 representing a reconfigurable partition of a hardware processing entity, for example by time sharing or by parallel processing circuitry. A number of these may be hosted by a hard partitioned entity nPAR 620 representing for example a circuit board mounting a number of the hardware processing entities. Multiple nPARs make up a physical computer 630 which is typically coupled to a network by network interface 650, and coupled to storage such as via a storage area network SAN interface 640.

There are many commercial storage virtualization products on the market from HP, IBM, EMC and others. These products are focused on managing the storage available to physical machines and increasing the utilization of storage. Virtual machine technology is a known mechanism to run operating system instances on one physical machine independently of other operating system instances. It is known, within a single physical machine, to have two virtual machines connected by a virtual network on this machine. VMware is a known example of virtual machine technology, and can provide isolated environments for different operating system instances running on the same physical machine.

There are also many levels at which virtualization can occur. For example HP's cellular architecture allows a single physical computer to be divided into a number of hard partitions or nPARs. Each nPAR appears to the operating system and applications as a separate physical machine. Similarly each nPAR can be divided into a number of virtual parititions or vPARs and each vPAR can be divided into a number of virtual machines (e.g. HPVM, Xen, VMware).

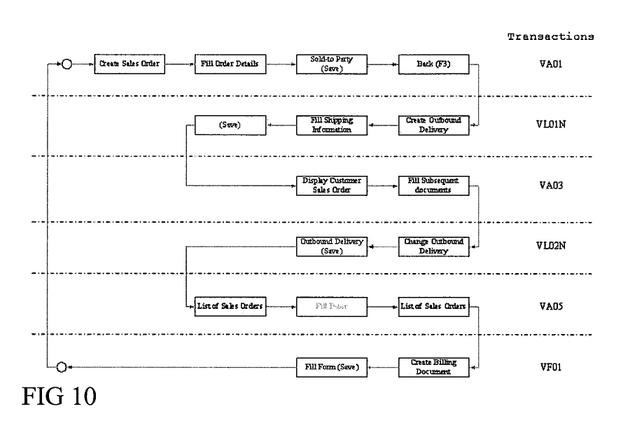

FIGS. 10 to 15

The next part of this document describes in more detail with reference to FIGS. 10 to 15 examples of models that can be used within the Model Information Flow (MIF) shown in FIGS. 1 to 9, particularly FIG. 4. These models can be used to manage an SAP application or other business process through its entire lifecycle within a utility infrastructure. The diagrams are shown using the well known UML (Unified Modelling Language) that uses a CIM (common information model) style. The implementation can be in Java or other software languages.

A custom model can have a 1-1 correspondence between an instance of an AIService and a BusinessProcess. The AIService is the information service that implements the business process.

A business process can be decomposed into a number of business process steps (BPsteps), so instances of a BusinessProcess class can contain 1 or more BPSteps. An instance of a BPStep may be broken into multiple smaller BPSteps involving sequences, branches, recursions and loops for example. Once the BusinessProcess step is decomposed into sufficient detail, each of the lowest level BPSteps can be matched to an ApplicationComponent. An ApplicationComponent is the program or function that implements the BPStep. For SAP, an example would be the SAP transaction named VA01 in the SD (Sales and Distribution package) of SAP R/3 Enterprise. Another example could be a specific Web Service (running in an Application Server).

BPStep can have stepType and stepParams fields to describe not only execution and branching concepts like higher-level sequences of steps, but also the steps themselves. The stepType field is used to define sequential or parallel execution, loops, and if-then-else statements. The stepParams field is used to define associated data. For example, in the case of a loop, the stepParams field can be the loop count or a termination criterion. The set of BPSteps essentially describes a graph of steps with various controls such as loops, if-then-else statements, branching probabilities, etc.

The relation BPStepsToApplicationComponentMapping is a complex mapping that details how the BPStep is mapped to the ApplicationComponent. It represents, in a condensed form, a potentially complex mix of invocations on an Application Component by the BPStep, such as the specific dialog steps or functions invoked within the ApplicationComponent or set of method calls on a Web Service, and provided details of parameters, such as the average number of line items in a sales order.

A BPStep may have a set of non-functional requirements (NonFunctionalRequirements) associated with it: performance; availability, security and others. Availability and security requirements could be modelled by a string: “high”, “medium”, “low”. Performance requirements are specified in terms of for example a number of registered users (NoUsersReq), numbers of concurrent users of the system, the response time in seconds and throughput requirement for the number of transactions per second. Many BPSteps may share the same set of non-functional requirements. A time function can be denoted by a string. This specifies when the non-functional requirements apply, so different requirements can apply during office-hours to outside of normal office hours. Richer time varying functions are also possible to capture end of months peaks and the like.

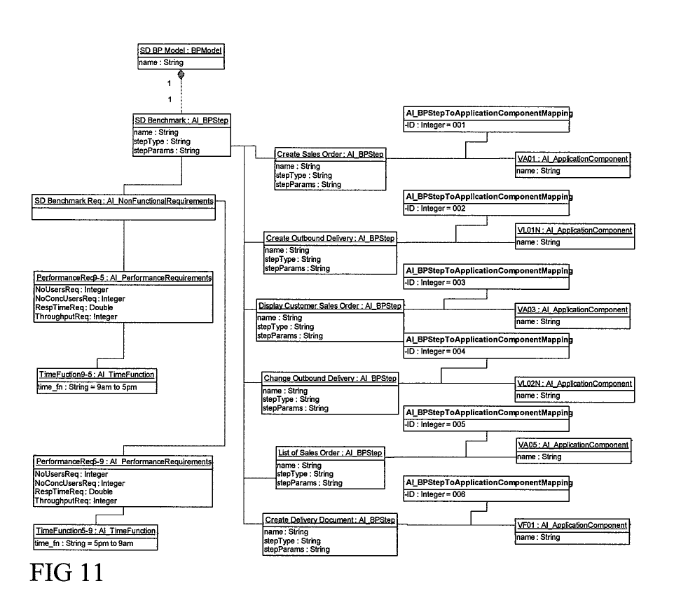

FIGS. 10, 11 Custom Model

For an example of a Custom Model the well-known Sales and Distribution (SD) Benchmark will be discussed. This is software produced by the well known German company SAP. It is part of the SAP R/3 system, which is a collection of software that performs standard business functions for corporations, such as manufacturing, accounting, financial management, and human resources. The SAP R/3 system is a client server system able to run on virtually any hardware/software platform and able to use many different database management systems. For example it can use an IBM AS/400 server running operating system OS/400 using database system DB2; or a Sun Solaris (a dialect of Unix) using an Oracle database system; or an IBM PC running Windows NT using SQL Server.

SAP R/3 is designed to allow customers to choose their own set of business functions, and to customize to add new database entities or new functionality. The SD Benchmark simulates many concurrent users using the SD (Sales and Distribution) application to assess the performance capabilities of hardware. For each user the interaction consists of 16 separate steps (Dialog Steps) that are repeated over and over. The steps and their mapping to SAP transactions are shown in FIG. 10. A transaction here is an example of an Application Component. Each transaction is shown as a number of boxes in a row. A first box in each row represents a user invoking the transaction e.g. by typing /nva01 to start transaction VA01. As shown in FIG. 10, transaction VA01 in the top row involves the business process steps of invoking the create sales order transaction, then filling order details, then saving the sold-to party, and completing with the “back” function F3 which saves the data.

A next transaction VL01N is shown in the second row, and involves steps as follows to create an outbound delivery. The transaction is invoked, shipping information is filled in, and saved. A next transaction VA03 is shown in the third row for displaying a customer sales order. This involves invoking the transaction, and filling subsequent documents. A fourth transaction is VL02N in the fourth row, for changing an outbound delivery. After invoking this transaction, the next box shows saving the outbound delivery. A next transaction shown in the fifth row is VA05, for listing sales orders. After invoking this transaction, the next box shows prompting the user to fill in dates and then a third box shows listing sales orders for the given dates. Finally, in a sixth row, the transaction VF01 is for creating a billing document, and shows filling a form and saving the filled form.

FIG. 11 shows an example of a custom model instance for the SD Benchmark. The top two boxes indicate that the business process “BPModel” contains one top level BPStep: “SD Benchmark”, with stepType=Sequence. Two lines are shown leading from this box, one to the non-functional requirements associated with this top-level BPStep, and shown by the boxes at the left hand side. In this particular case only performance requirements have been specified—one for 9 am-5 pm and the other for 5 pm-9 am. Other types of non-functional requirements not shown could include security or availability requirements for example. In each case the performance requirements such as number of users, number of concurrent users, response time required, and throughput required, can be specified as shown. These are only examples: other requirements can be specified to suit the type of business process. A box representing the respective time function is coupled to each performance requirement box as shown. One indicates 9 am to 5 pm, and the other indicates 5 pm to 9 am in this example.

On the right hand side a line leads from the SD Benchmark BPStep to the functional requirements shown as six BPSteps, with stepType=Step—one for each SAP transaction shown in FIG. 10 (VA01, VL01N, etc). For convenience the name of the first dialog step for each transaction shown in FIG. 10 is used as the name of the corresponding BPStep shown in FIG. 11 (“Create sales order”, “Create outbound delivery”, “Display customer sales order”, “Change outbound delivery”, “List sales order”, and “Create delivery document”). For each of these steps the BPStepToApplicationComponentMapping relation specifies the details of the dialog steps involved. For example in the case of CreateSalesOrder, FIG. 10 shows that the BPStepToApplicationComponentMapping needs to specify the following dialog steps are executed in order: “Create Sales Order”, “Fill Order Details”, “Sold to Party” and “Back”. In addition it might specify the number of line items needed for “Fill Order Details”. At the right hand side of the figure, each BP step is coupled to an instance of its corresponding ApplicationComponent via the respective mapping. So BPstep “Create Sales order” is coupled to ApplicationComponent VA01, via mapping having ID:001. BPstep “Create outbound delivery” is coupled to ApplicationComponent VL01N via mapping having ID:002. BPstep “Display customer sales order” is coupled via mapping having ID:003 to ApplicationComponent VA03. BPstep “Change outbound delivery” is coupled via mapping having ID:004 to ApplicationComponent VL02N. BPstep “List sales order” is coupled via mapping having ID:005 to ApplicationComponent VA05. BPstep “Create delivery document” is coupled via mapping having ID:006 to ApplicationComponent VF01.

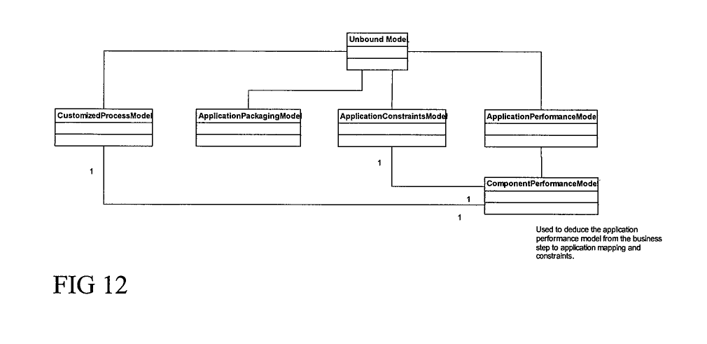

FIG. 12, The Unbound Model

The Unbound Model is used to calculate resource demands. As shown in FIG. 12 this model can be made up of four models: the Custom Model (labelled CustomizedProcessingModel), Application Packaging, Application Constraints and Application Performance models, an example of each of which will be described below (other than the Custom Model, an example of which has been described above with respect to FIG. 11). Other arrangements can be envisaged. No new information is introduced that is not already contained in these four models.

FIG. 12, Application Packaging Model

The Application Packaging Model describes the internal structure of the software: what products are needed and what modules are required from the product. An ApplicationComponent can be contained in an ApplicationModule. An ApplicationModule might correspond to a JAR (Java archive) file for an application server, or a table in a database. In the case of SAP it might be the module to be loaded from a specific product into an application server such as SD or FI (Financials). The application packaging model can have a DiskFootPrint to indicate the amount of disk storage required by the ApplicationModule. In the case of the ApplicationComponent VA01 in FIG. 10, it is from SD with a DiskFootPrint of 2 MB for example.

One or more ApplicationModules are contained within a product. So for example SAP R/3 Enterprise contains SD. ApplicationModules can be dependent on other ApplicationModules. For example the SD Code for the Application Server depends on both the SD Data and the SD Executable code being loaded into the database.

The custom model can have an ApplicationExecution Component for executing an ApplicationComponent. This could be a servlet running in an application server or a web server. It could also be a thread of a specific component or a process. In the case of SD's VA01 transaction it is a Dialog Work Process. When it executes, the

ApplicationComponent may indirectly use or invoke other Application-Components to run: a servlet may need to access a database process; SD transactions need to access other ApplicationComponents such as the Enqueue Work Process and the Update Work Process, as well as the Database ApplicationExecutionComponent. The ApplicationExecution Component can be contained by and executed in the context of an ApplicationExecutionService (SAP application server) which loads or contains ApplicationModules (SD) and manages the execution of ApplicationExecutionComponents (Dialog WP) which, in turn, execute the ApplicationComponent (VA01) to deliver a BPStep.

FIG. 12, Application Constraints Model

The Application Constraints Model expresses arbitrary constraints on components in the Customized Process, Application Packaging and Component Performance Models. These constraints are used by tools to generate additional models as the MIF progresses from left to right. Examples of constraints include:
How to scale up an application server—what ApplicationExecutionComponents are replicated and what are not. For example, to scale up an SAP application server to deal with more users one cannot simply replicate the first instance—the master application server 50 of FIGS. 7 and 8, commonly known as the Central Instance. Instead a subset of the components within the Central Instance is needed. This is also an example of design practice: there may be other constraints encoding best design practice.
Installation and configuration information for ApplicationComponents,

ApplicationExecutionComponents and ApplicationExecutionServices
Performance constraints on ApplicationExecutionServices—e.g. do not run an application server on a machine with greater than 60% CPU utilization

Other examples of constraints include ordering: the database needs to be started before the application server. Further constraints might be used to encode deployment and configuration information. The constraints can be contained all in the templates, or provided in addition to the templates, to further limit the number of options for the grounded model.

FIG. 12, Application Performance Model

The purpose of the Application Performance Model is to define the resource demands for each BPStep. There are two types of resource demand to consider.
1. The demand for resources generated directly by the ApplicationExecutionComponent (e.g. Dialog WP) using CPU, storage I/O, network I/O and memory when it executes the BPStep—the ComponentResourceDemand
2. The demand for resources generated by components that the above ApplicationExecutionComponent causes when it uses, calls or invokes other components (e.g. a Dialog WP using an Update WP)—the IndirectComponentResourceDemand

The IndirectComponentResourceDemand is recursive. So there will be a tree like a call-graph or activity-graph.

A complete Application Performance Model would contain similar information for all the BPSteps shown in FIG. 11. For example the set of dialog steps in the BPStep “Create Sales Order” might consume 0.2 SAPS. Further it consists of 4 separate invocations (or in SAP terminology Dialog Steps). The calls are synchronous.

The following are some examples of attributes that can appear in IndirectComponentResourceDemands and ComponentResourceDemands.
delayProperties: Any delay (e.g. wait or sleep) associated with the component's activity which does not consume any CPU, NetIOProperties and DiskIOProperties.
NumInvocation: The number of times the component is called during the execution of the BPStep.
InvocationType: synchronous if the caller is blocked; asynchronous if the caller can immediately continue activity.
BPStepToAppCompID: This is the ID attribute of the BPStepToApplicationComponent-Mapping. The reason for this is that a particular ApplicationExecutionComponent is likely to be involved in several different BPSteps.
ApplicationEntryPoint: This is the program or function being executed. In the case of “Create Sales Order” this is VA01 for the DialogWP. It could also be a method of a Web Service.

CPUProperties can be expressed in SAPs or in other units. There are various ways to express MemProperties, NetIOProperties and DiskIOProperties.

FIG. 12, Component Performance Model

There is one instance of an Application Performance Model for each instance of a Custom Model. This is because, in the general case, each business process will have unique characteristics: a unique ordering of BPSteps and/or a unique set of data characteristics for each BPStep. The DirectComponentResourceDemands and IndirectComponentResourceDemands associations specify the unique resource demands for each BPStep. These demands need to be calculated from known characteristics of each ApplicationComponent derived from benchmarks and also traces of installed systems.

The Component Performance Model contains known performance characteristics of each ApplicationComponent. A specific Application Performance Model is calculated by combining the following:
The information contained in the BPStepToApplicationComponentMapping associations in the Custom Model
Any performance related constraints in the Application Constraints Model
The Component Performance Model

Taken together, the models of the Unbound Model specify not only the non-functional requirements of a system, but also a recipe for how to generate and evaluate possible software and hardware configurations that meet those requirements. The generation of possible hardware configurations is constrained by the choice of infrastructure available from a specific Infrastructure Provider, using information in an Infrastructure Capability Model, and by the selected template.

A general principle that applies to deployable software elements described in the Unbound Model, such as the ApplicationExecutionComponent or ApplicationExecutionService, is that the model contains only the minimum number of instances of each type of element necessary to describe the structure of the application topology. For example, in the case of SD only a single instance of a Dialog Work Process ApplicationExecutionComponent associated with a single instance of an Application Server ApplicationExecutionService is needed in the Unbound Model to describe the myriad of possible ways of instantiating the grounded equivalents of both elements in the Grounded Model. It is the template and packaging information that determines exactly how these entities can be replicated and co-located.

The Infrastructure Capability Model

As discussed above, two notable features of the modelling philosophy described are:
1. Present a template having a finite catalogue of resources that can be instantiated, so that there are a fixed and finite number of choices. For example, small-xen-vm 1-disk, medium-xen-vm 2-disk, large-xen-vm 3-disk, physical-hpux-machine etc. This makes the selection of resource type by any capacity planning tool simpler. It also makes the infrastructure management easier as there is less complexity in resource configuration—standard templates can be used.
2. Do not expose the hosting relationship for virtualized resources. The DMTF Virtualization System Profile models hosting relationship as a “HostedDependency” association. This does not seem to be required if there is only a need to model a finite number of resource types, so it does not appear in any of the models discussed here. This keeps the models simpler since there is no need to deal with arbitrary recursion. It does not mean that tools that process these models can't use the DMTF approach internally if that is convenient. It may well be convenient for a Resource Directory Service and Resource Assignment Service to use this relationship in their internal models.

An instance of an infrastructure capability model contains one instance for each type of ComputerSystem or Device that can be deployed and configured by the underlying utility computing fabric. Each time the utility deploys and configures one of these types the configuration will always be the same. For a ComputerSystem this means the following.
Same memory, CPU, Operating System
Same number of NICs with same I/O capacity
Same number of disks with the same characteristics

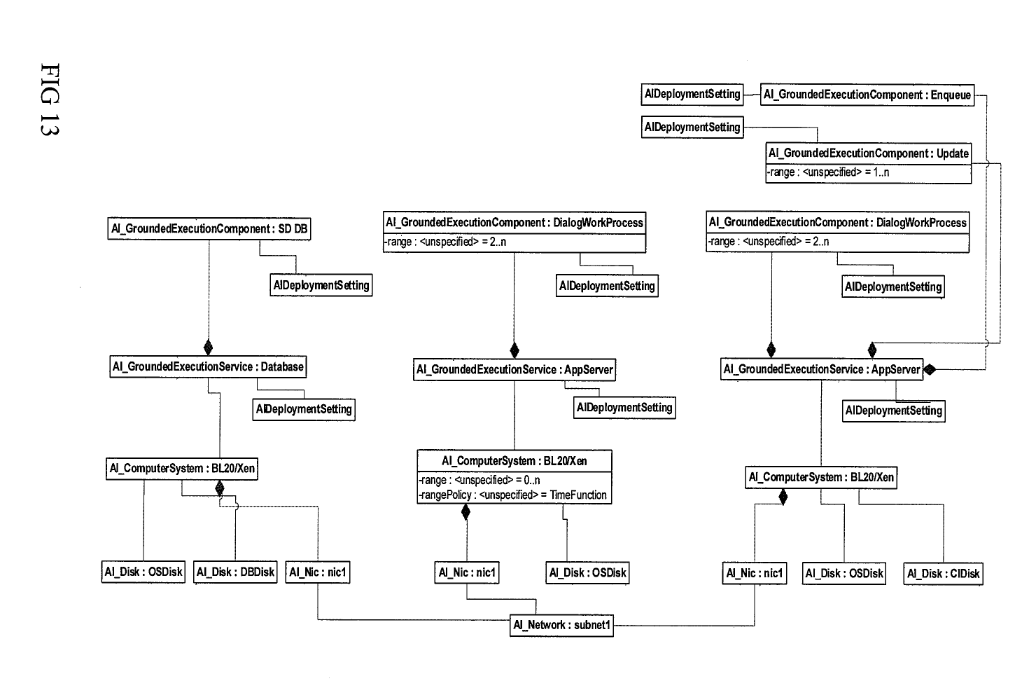

FIG. 13 Template Example

FIG. 13 shows an example of an infrastructure design template having predetermined parts of the computing infrastructure, predetermined relationships between the parts, and having a limited number of options to be completed. In this case it is suitable for a decentralised SD business process, without security or availability features. The figure shows three computer systems coupled by a network labelled “AI_network”, the right hand of the three systems corresponding to a master application server, and the central one corresponds to slave application servers as shown in FIG. 7. Hence it is decentralized. AI is an abbreviation of Adaptive Infrastructure. The left hand one of the computer systems is for a database. The type of each computer system is specified, in this case as a BL20/Xen. The central one, corresponding to slave application servers has an attribute “range=0 . . . n”. This means the template allows any number of these slave application servers.

The master application server is coupled to a box labelled AI_GroundedExecutionService:AppServer, indicating it can be used to run such a software element. It has an associated AIDeploymentSetting box which contains configuration information and deployment information sufficient to allow the AI_GroundedExecutionService to be automatically installed, deployed and managed. The AI_GroundedExecutionService:AppServer is shown as containing three components, labelled AI_GroundedExecutionComponents, and each having an associated AIDeploymentSetting box. A first of these components is a dialog work process, for executing the application components of steps of the business process, another is an update process, responsible for committing work to persistent storage, and another is an enqueue process, for managing locks on a database. As shown, the range attribute is 2 . . . n for the update and the dialog work process, meaning multiple instances of these parts are allowed.

The slave application server has a GroundedExecutionService having only one type of AI_GroundedExecutionComponent for any number of dialog work processes. The slave application server is shown having a rangePolicy=Time function, meaning it is allowed to be active at given times. Again the service and the execution component each have an associated AIDeploymentSetting box.

The master and slave application servers and the database computer system have an operating system shown as AI_disk: OSDisk. The master application server is shown with an AI_Disk: CIDisk as storage for use by the application components. For the network, each computer system has a network interface shown as AI_Nic1, coupled to the network shown by AI_Network:subnet1.

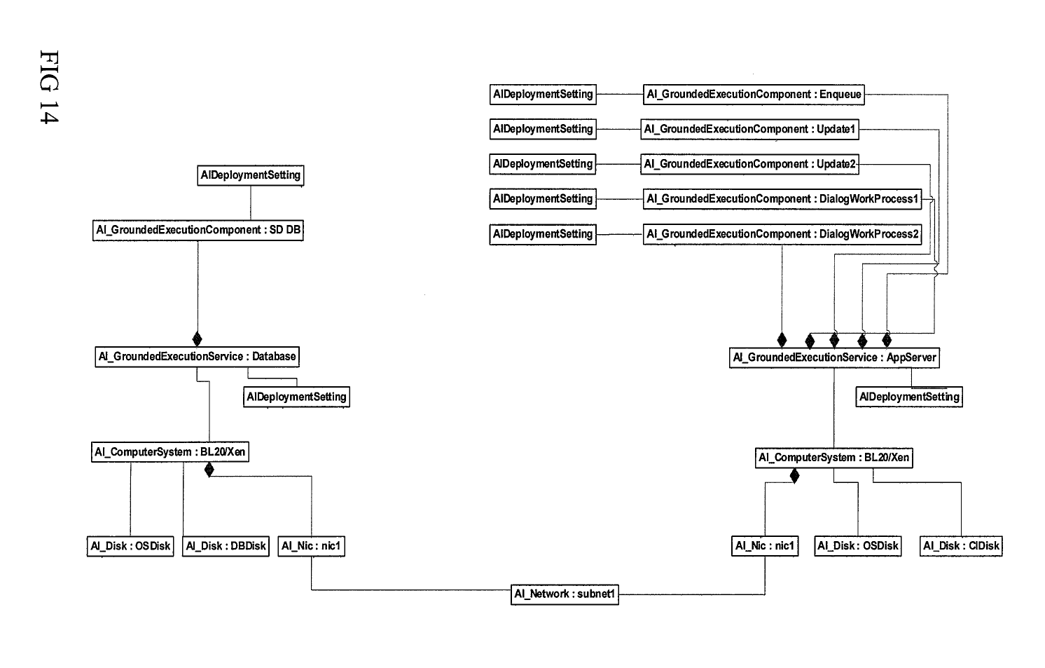

The database computer system is coupled to a box labelled AI_GroundedExecutionService: Database, which has only one type of AI_GroundedExecutionComponent, SD DB for the database. Again the service and the execution component each have an associated AIDeploymentSetting box. AIDeploymentSetting carries the configuration and management information used to deploy, configure, start, manage and change the component. Further details of an example of this are described below with reference to FIG. 14. This computer system is coupled to storage for the database labelled AI_Disk: DBDisk.

Optionally the template can have commands to be invoked by the tools, when generating the grounded model, or generating a changed grounded model to change an existing grounded model. Such commands can be arranged to limit the options available, and can use as inputs, parts of the template specifying some of the infrastructure design. They can also use parts of the unbound model as inputs.

FIG. 14 Grounded Model

The Grounded Model may be generated by a design tool as it transforms the Unbound Model into the Grounded Model. It can be regarded as a candidate Grounded Model until evaluated and selected as the chosen Grounded Model. The following are some of the characteristics of the example Grounded Model of FIG. 14 compared to the template shown in FIG. 13, from which it is derived.
The number of instances of GroundedExecutionComponent has been specified.
The GroundedExecutionComponents are executed by a GroundedExecutionService. The execution relationship is consistent with that expressed in the Application Packaging Model.
The GroundedExecutionServices are run on a ComputerSystem whose type has been selected from the Infrastructure Capability Model.
There are two update components, Update1 and Update2. There are two DialogWorkProcesses, DialogWorkProcess1 and DialogWorkProcess2.
The number of slave application servers has been set at zero.

The management system is arranged to make these choices to derive the Grounded Model from the template using the Unbound Model. In the example shown, the criteria used for the choice includes the total capacity of the system, which must satisfy the time varying Performance Requirements in the Custom Model. The required capacity is determined by combining these Performance Requirements with the aggregated ResourceDemands [Direct and Indirect] of the Application Performance Model. If the first choice proves to provide too little capacity, or perhaps too much, then other choices can be made and evaluated. Other examples can have different criteria and different ways of evaluating how close the candidate grounded model is to being a best fit.

In some examples the server may only have an OS disk attached; that is because the convention in such installations is to NFS mount the CI disk to get its SAP executable files. Other example templates could have selectable details or options such as details of the CIDisk and the DBDisk being 100 GB, 20 MB/sec, non Raid, and so on. The OS disks can be of type EVA800. The master and slave application servers can have 2 to 5 dialog work processes. Computer systems are specified as having 3 GB storage, 2.6 GHz CPUs and SLES 10-Xen operating system for example. Different parameters can be tried to form candidate Grounded Models which can be evaluated to find the best fit for the desired performance or capacity or other criteria.

The Grounded Model therefore specifies the precise number and types of required instances of software and hardware deployable entities, such as GroundedExecutionComponent, GroundedExecutionService, and AIComputerSystem. AIDeploymentSettings can include for example:
InfrastructureSettings such as threshold information for infrastructure management components, for example MaxCPUUtilization—if it rises above the set figure, say 60%, an alarm should be triggered.
Management policy can specify further policy information for the management components—e.g. flex up if utilization rises above 60%
GroundedDeploymentSettings which can include all command line and configuration information so that the system can be installed, configured and started in a fully functional state.
SettingData which can provide additional configuration information that can override information provided in the GroundedDeploymentSettings. This allows many GroundedComponents to share the same GroundedDeploymentSettings (c.f. a notion of typing) with specific parameters or overrides provided by SettingData. Both the GroundedDeploymentSettings and SettingData are interpreted by the Deployment Service during deployment.
Data related to possible changes to the component such as instructions to be carried out when managing changes to the component, to enable more automation of changes.

Not all attributes are set in the Grounded Model. For example, it does not make sense to set MAC addresses in the Grounded Model, since there is not yet any assigned physical resource.

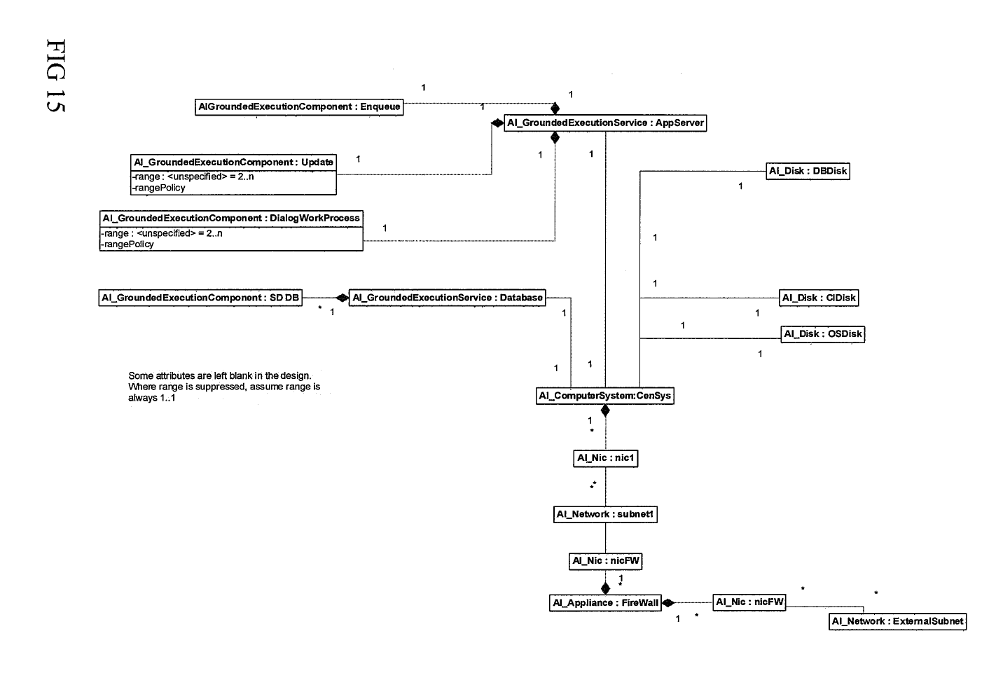

FIG. 15, An Alternative Adaptive Infrastructure Design Template

FIG. 15 shows an alternative adaptive infrastructure design template, in a form suitable for a centralised secure SD business process. Compared to FIG. 13, this has only one computer system, hence it is centralised. It shows security features in the form of a connection of the network to an external subnet via a firewall. This is shown by an interface AI_Nic:nicFW, and a firewall shown by AI_Appliance: FireWall. Other templates can be envisaged having any configuration. Other examples can include a decentralised secure SD template, a decentralised highly available SD template, and a decentralised, secure and highly available SD template.

Bound Model

A Bound Model Instance for a SD system example could have in addition to the physical resource assignment, other parameters set such as subnet masks and MAC addresses. A Deployed Model could differ from the Bound Model in only one respect. It shows the binding information for the management services running in the system. All the entities would have management infrastructure in the form of for example a management service. The implementation mechanism used for the interface to the management services is not defined here, but could be a reference to a Web Service or a SmartFrog component for example. The management service can be used to change state and observe the current state. Neither the state information made available by the management service, nor the operations performed by it, are necessarily defined in the core of the model, but can be defined in associated models.

One example of this could be to manage a virtual machine migration. The application managing the migration would use the management service running on the PhysicalComputerSystem to do the migration. Once the migration is completed, the management application would update the deployed model and bound models to show the new physical system. Care needs to be taken to maintain consistency of models. All previous model instances are kept in the model repository, so when the migration is complete, there would be a new instance (version) of the bound and deployed models.

Information Hiding and the Model Information Flow

It is not always the case that for the MIF all tools and every actor can see all the information in the model. In particular it is not the case for deployment services having a security model which requires strong separation between actors. For example, there can be a very strong separation between the utility management plane and farms of virtual machines. If a grounded model is fed to the deployment services of the management plane for an enterprise, it will not return any binding information showing the binding of virtual to physical machines, that information will be kept inside the management plane. That means there is no way of telling to what hardware that farm is bound or what two farms might be sharing. What is returned from the management plane could include the IP address of the virtual machines in the farms (it only deals with virtual machines) and the login credentials for those machines in a given farm. The management plane is trusted to manage a farm so that it gets the requested resources. Once the deployment service has finished working, one could use application installation and management services to install, start and manage the applications. In general different tools will see projections of the MIF. It is possible to extract from the MIF models the information these tools require and populate the models with the results the tools return. It will be possible to transform between the MIF models and the data format that the various tools use.

Implementation:

The software parts such as the models, the model repository, and the tools or services for manipulating the models, can be implemented using any conventional programming language, including languages such as Java, or C compiled following established practice. The servers and network elements can be implemented using conventional hardware with conventional processors. The processing elements need not be identical, but should be able to communicate with each other, e.g. by exchange of IP messages.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles behind the invention and its practical applications to enable one skilled in the art to utilize the invention in various embodiments and with various modifications as are suited to the particular use contemplated. Other variations can be conceived within the scope of the claims.

1. A method of setting up a development environment for development work on a computer based business process, the method having the steps of:
providing a model of the business process, the model representing functional steps of the business process, an arrangement of software application components, for carrying out the functional steps, and a design of computing infrastructure, for running the software application components,
providing in the model a representation of one or more tools for developing part of the business process, incorporated with the corresponding part of the modelled business process, and
deploying at least part of the model incorporating the tools, and installing the given tools, to set up the development environment.

2. The method of claim 1, at least part of the modelled tools being incorporated in a template which allows some parameters to be selectable, and the method having the step of completing the template by selecting parameters allowed by the template.

3. The method of claim 2, the template having configuration information to enable the installation of the tools to include setting up interfaces with the deployed parts of the model of the business process.

4. The method of claim 2, having the step of prompting a developer to select the template from a number of predetermined templates of computing infrastructure design.

5. The method of claim 2, having the step of presenting options constrained by the template to a developer for selecting and configuring the tools.

6. The method of claim 2, having the step of using the template to provide a mapping of logical components of an unbound model of the parts of the business process and of the model of the selected tools on to the computing infrastructure, to provide a grounded model of the business process, with the selected tools incorporated, suitable for automated deployment.

7. The method of claim 1, the tools being part of an integrated development environment associated with at least one of the software application components, and the model having a representation of the integrated development environment in the model.

8. The method of claim 1, the tools comprising testing tools and the method having the step of deploying the testing tools so that they are set up to provide test inputs, and to monitor of parts of the deployed business process under test conditions.

9. The method of claim 1, having the step of generating the representations of the development tools.

10. Software on a computer readable medium which when executed will carry out the method of setting up a development system according to claim 1.

11. A method of using a management system to set up a development environment for development work on a computer based business process, the management system having:
a store having a model of the business process, the model representing functional steps of the business process, an arrangement of software application components, for carrying out the functional steps, and a design of computing infrastructure, for running the software application components,
the model having a representation of one or more tools for developing part of the process, incorporated with a corresponding part of the modelled business process, and a deployment part for deploying at least part of the model incorporating the tools, and installing the given tools, to set up the development environment,
the method having the steps by a developer of selecting which tools are to be used, and causing the deployment part to deploy the model incorporating the selected tools:

12. A management system for setting up a development environment with tools for development work on a computer based business process, the management system having:
a store for storing a model of the business process, the model representing functional steps of the business process, an arrangement of software application components, for carrying out the functional steps, and a design of computing infrastructure, for running the software application components,
model having a representation of one or more tools for developing part of the process, incorporated with a corresponding part of the modelled business process, and a deployment part arranged to deploy at least part of the model incorporating the tools, and to install the given tools, to set up the development environment.

13. The system of claim 12, at least part of the modelled tools being incorporated in a template which allows some parameters to be selectable, and the management system being arranged to complete the template by selecting parameters allowed by the template.

14. The system of claim 13, the template having configuration information to enable the installation of the tools to include setting up interfaces with the deployed parts of the model of the business process.

15. The system of claim 13, the system being arranged to prompt a developer to select the template from a number of predetermined templates of computing infrastructure design.

16. The system of claim 13, the system being arranged to present options constrained by the template to a developer for selecting and configuring the tools.

17. The system of claim 13, being arranged to use the template to provide a mapping of logical components of an unbound model of the parts of the business process and of the model of the selected tools on to the computing infrastructure, to provide a grounded model of the business process, with the selected tools incorporated, suitable for automated deployment.

18. The system of claim 12, the tools being part of an integrated development environment associated with at least one of the software application components, and the model having a representation of the integrated development environment in the model.

19. The system of claim 12, the tools comprising testing tools and the deployment part being arranged to deploy the testing tools so that they are set up to provide test inputs, and to monitor of parts of the deployed business process under test conditions.

20. The system of claim 12, arranged to generate the representations of the development tools.

21. The system of claim 12, the design of computing infrastructure having virtualized entities.
